(19) United States
(12) Patent Application Publication
(10) Pub. No.: US 2018/0063494 A1
(43) Pub. Date: Mar. 1, 2018

(54) IMAGE PROJECTING SYSTEM, INFORMATION PROCESSING APPARATUS, AND METHOD FOR IMAGE PROJECTING

(71) Applicant: Kazuhide Tanabe, Kanagawa (JP)

(72) Inventor: Kazuhide Tanabe, Kanagawa (JP)

(21) Appl. No.: 15/691,206

(22) Filed: Aug. 30, 2017

(30) Foreign Application Priority Data
Aug. 31, 2016 (JP) 2016-169179

(51) Int. Cl. H04N 9/31; G03B 21/62

(52) U.S. Cl. CPC H04N 9/3147; H04N 9/3164; G03B 21/62; H04N 9/3179; H04N 9/3155

(57) ABSTRACT

An image projection apparatus includes processing circuitry. The processing circuitry is configured to divide an image into a plurality of divided images in accordance with positions and sizes of a plurality of surfaces in a projection region. The processing circuitry is further configured to control a plurality of projection devices to project the plurality of divided images onto the plurality of projection surfaces, each projection device of the plurality of projection devices corresponding to a different projection surface of the plurality of surfaces and projecting a divided image onto the corresponding different projection surface. The processing circuitry is further configured to control operation of another apparatus based on a timing so as to control an amount of light projected from a light source of a plurality of light sources. The plurality of light sources may include the plurality of projection devices.

### CROSS-REFERENCE TO RELATED APPLICATION

This patent application is based on and claims priority pursuant to 35 U.S.C. §119(a) to Japanese Patent Application No. 2016-169179, filed on Aug. 31, 2016, the entire disclosure of which is hereby incorporated by reference herein.

### BACKGROUND

### Technical Field

The present disclosure relates to an image projecting system, an information processing apparatus, and method for image projecting.

### Description of the Related Art

Digital signage is widely used. The digital signage distributes contents such as movie or images to an image projecting device and projects the contents on a large screen set outdoor, shop front, public space. In the case of digital signage, the content suitable for time and place is projected in real time, so high advertisement effect is expected.

### SUMMARY

An image projection apparatus includes processing circuitry. The processing circuitry is configured to divide an image into a plurality of divided images in accordance with positions and sizes of a plurality of surfaces in a projection region. The processing circuitry is further configured to control a plurality of projection devices to project the plurality of divided images onto the plurality of projection surfaces, each projection device of the plurality of projection devices corresponding to a different projection surface of the plurality of surfaces and projecting a divided image onto the corresponding different projection surface. The processing circuitry is further configured to control operation of another apparatus based on a timing so as to control an amount of light projected from a light source of a plurality of light sources. The plurality of light sources may include the plurality of projection devices.

### BRIEF DESCRIPTION OF THE DRAWINGS

A more complete appreciation of the embodiments and many of the attendant advantages and features thereof can be readily obtained and understood from the following detailed description with reference to the accompanying drawings:

FIG. 1 illustrates an example of projection by an image projection system;

FIGS. 2A, 2B and 2C illustrate an example of operation of each signage apparatus set on the each window of building;

FIG. 3 illustrates an example configuration of the image projection system according to an embodiment of the present disclosure;

FIG. 4 illustrates an example hardware configuration of a piece of information processing apparatus according to an embodiment of the present disclosure;

FIGS. 5A and 5B illustrate an example of signage target information;

FIG. 6 illustrates an example of image information;

FIG. 7 illustrates an example of schedule information;

FIG. 8 illustrates a flowchart diagram including steps in an operation of signage;

FIG. 9 illustrates an example functional configuration of the calibration part of the information processing apparatus;

FIGS. 10A and 10B illustrate a sequence diagram including steps in a first calibration process;

FIG. 11 illustrates an example of a screen displayed on the information processing apparatus during the first calibration process;

FIG. 12 illustrates an example of a pattern image projected during the first calibration process;

FIG. 13 illustrates another example of a pattern image projected during the first calibration process;

FIG. 14 illustrates a sequence diagram including steps in a second calibration process;

FIG. 15 illustrates an example of a white image projected during the second calibration process;

FIG. 16 illustrates an example functional configuration of the image process part of the information processing apparatus;

FIG. 17 illustrates an example of operation of an image process;

FIG. 18 illustrates a flowchart diagram including steps in the image process;

FIG. 19 illustrates a flowchart diagram including steps in a first division process;

FIG. 20 illustrates an illustration for describing an example of operation of the first division process;

FIG. 21 illustrates a block diagram of an example functional configuration of the signage controlling part of the information processing apparatus;

FIG. 22 illustrates a flowchart diagram including steps in a signage process;

FIGS. 23A and 23B illustrate a view of an example of a screen displayed on the information processing apparatus during a schedule registration process;

FIGS. 24A, 24B and 24C illustrate a view of an example of a screen displayed on the information processing apparatus during a control information setting process;

FIGS. 25A, 25B and 25C are illustrations for describing an example of operation of switching order;

FIGS. 26A and 26B are illustrations for describing an example of required time information and instruction timing for instructing operation of each signage device from starting the projection;

FIG. 27 illustrates a flowchart diagram including steps in a starting control process;

FIGS. 28A and 28B are illustrations for describing an example of required time information and instruction timing for instructing operation of each signage device from ending the projection;

FIG. 29 illustrates a flowchart diagram including steps in an ending control process; and

FIGS. 30A and 30B are illustrations for describing another example of required time information and instruction timing for instructing operation of each signage device from ending the projection.

### DETAILED DESCRIPTION OF THE DRAWINGS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include both single and multiple forms, unless the context clearly indicates otherwise.

Hereinafter, a description is given in detail of several embodiments of an image projecting system, an information processing apparatus, method and computer readable medium for image projecting with reference to the appended drawings.

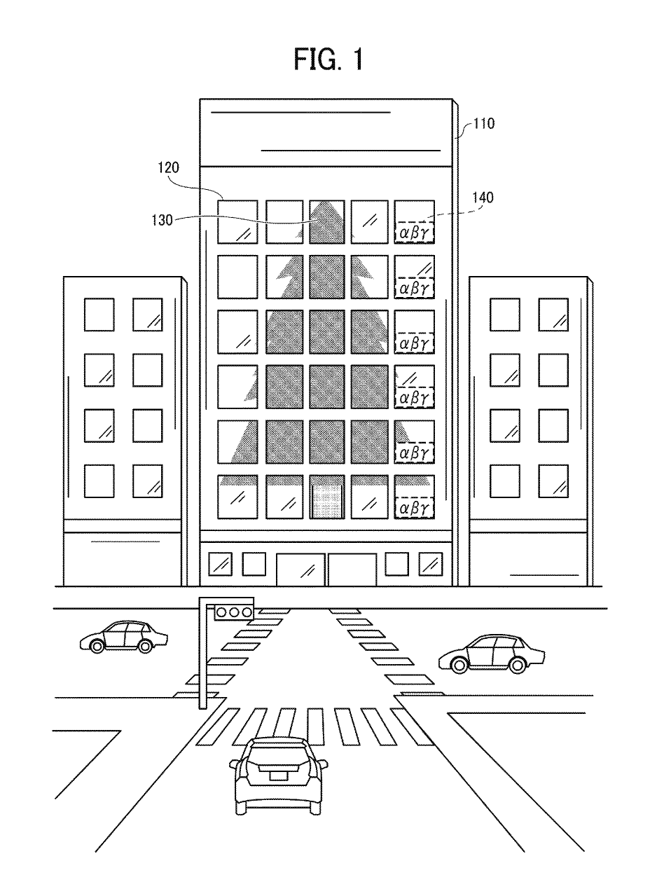

FIG. 1 illustrates an example of projection by an image projection system. As illustrated in FIG. 1, the image projection system realizes large-scale digital signage by combining and using a plurality of window glass (light transmitting surface) attached to the outer surface of a building 110.

As shown in FIG. 1, a plurality of window glasses (window glass group 120) are attached to the outer surface of the building 110 on the road side (30 pieces of window glasses in the example in FIG. 1). The image projection system projects, from the inside of the building 110, each projection movie or image to each of the window glasses. The projection movie or image(s) are included in the group of projection movie or image.

Thus, image projection system realizes a large scale digital signage using the area of 30 window glasses (in the example of FIG. 1, the image projection system is displaying a huge tree). In addition, the image projection system realizes digital signage at a place easily accessible to a passenger such as an outer surface on the road side. In other words, the image projection system realizes digital signage with high advertisement effect.

Further, according to the image projection system, compared to other digital signage such as a digital signage using a large screen previously installed or a side wall surface of a building without a window glass, the range of application of digital signage is expanded.

Furthermore, the image projection system also controls the operation of other apparatus capable of changing the amount of light and the color of light visually recognized from the outside of the building 110, such as an electric screen or an illumination device group 140 already installed on the window glass of the building 110. Thus, image projection system improves the visual effect of the digital signage by controlling the other apparatus (the illumination device group 140, the electric screen, etc.) according to the projection of the group of projection movie or image.

It should be noted that the other apparatuses are not limited to the illumination device group 140, the electric screen. The other apparatus is any device capable of adjusting (increasing, decreasing, turning on, turning off, blinking) the amount of light related to the light transmitting surface, for example, an illumination device inside the building 110, an illumination device that illuminates the wall surface or signboard from the outside of the building 110, or an electric blind arranged on the window glass.

For example, by darkening (turning off) the lighting device inside the building 110, when viewing the window glass from the outside, the projection surface becomes darker and the visibility is further improved. In addition, by darkening (turning off) light illuminating a wall surface or a signboard from the outside of the building 110, the brightness around the window glass becomes dark and the visibility of the projecting movie or image projected on the electric screen corresponding to the window glass.

In this manner, digital signage with higher visibility is realized by controlling devices that affect the light amount (or visibility) related to the light transmitting surface including the window glass. In addition, it is also possible to link the motion of the signage device (signboard, object etc.) already installed in the building 110 with the projection of the projection movie or image group 130.

Next, the operation of each signage device (which is referred to as a projector (projection device), an electric screen (projection surface), an illuminator in the present embodiment) comprising the image projection system is explained.

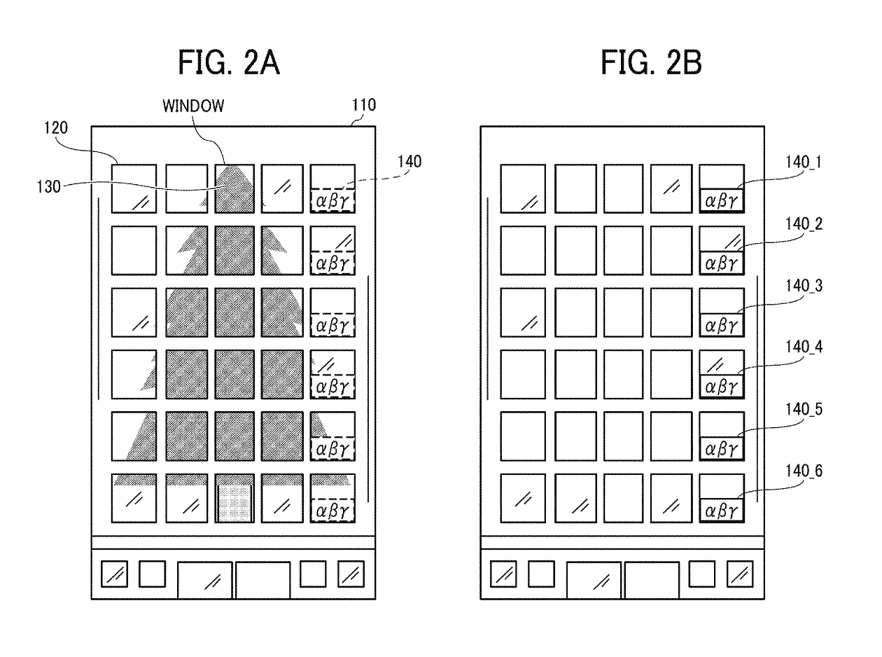

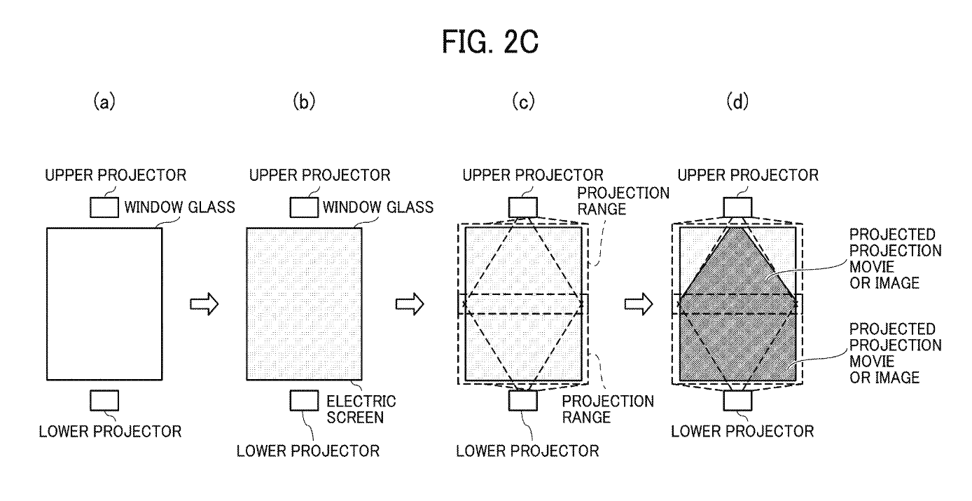

FIGS. 2A, 2B and 2C illustrate an example of operation of each signage apparatus set on the each window of building. From (a) to (d) in FIG. 2C are an illustration for the operation of electric screen and projector among each signage apparatus disposed inside the respective window grasses of the building 110 showed by FIG. 2A.

As shown in (a) of FIG. 2C, projectors are arranged on the upper and lower sides of each window glass of the building 110. For one window glass, a projection movie or image is projected using two projectors (upper projector and lower projector). Thus, even when the size of the window glass is large, an appropriate projection movie or image is projected.

Further, as shown in (b) of FIG. 2C, an electric screen is disposed inside each window glass of the building 110. When the projection movie or image is projected by using the projectors, each window glass is made translucent by setting the electric screen to the ON state for changing the light transmittance. In addition, the electric screen (projection surface) forms a light transmitting surface together with the window glass (projection target).

As illustrated in (c) of FIG. 2C, a state in which the lamps of the upper projector and the lower projector are turned on after turning on the electric screen. The projection range of the upper projector is the upper side of the window glass. The projection range of the lower projector is the lower side of the window glass. It should be noted that the upper projector and the lower projector are adjusted so that a part of the projection range overlaps. That is, in the present embodiment, the two projectors project projection movie or images to the projection range corresponding to the size of the window glass.

As illustrated in (d) of FIG. 2C, the projection movie or image is projected by the upper projector and the lower projector. In the image projection system according to the present embodiment, a projection movie or image is projected on each electric screen corresponding to each window glass included in the window glass group 120, thereby realizing one digital signage as a whole. Therefore, in each electric screen corresponding to each window glass, the projection movie or image generated based on the movie or image of the partial area of the original movie or image (provided by advertiser) is vertically divided and projected by the two projectors.

As shown in FIG. 2B, in the image projection system, in a state in which projection of the projection movie or image group 130 is completed, the illumination device group 140 (the illumination devices 140-1 to 140-6) and the electric screen is controlled to be in the OFF state.

That is, in the image projection system, the upper projector, the lower projector, the electric screen, and the decorative device group 140 operate in conjunction with each other.

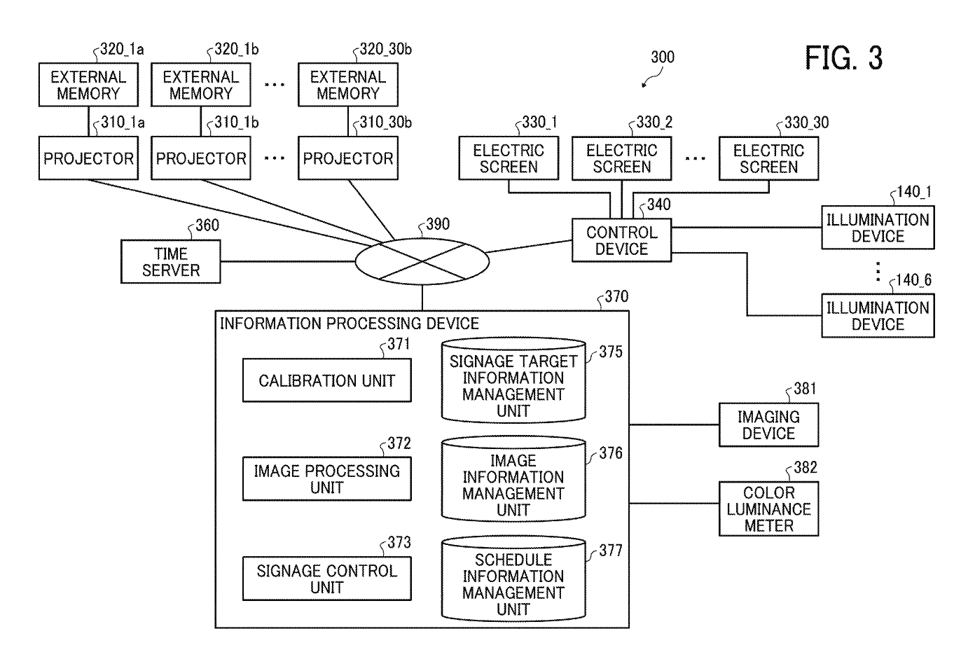

Next, the system configuration of the image projection system is described. FIG. 3 illustrates an example configuration of the image projection system. As shown in FIG. 3, the image projection system 300 includes projectors 310-1a to 310-30b, external memories 320-1a to 320-30b, electric screens 330-1 to 330-30, a control device 340, and illumination device 140-1 to 140-6. And the image projection system 300 includes time server 360, information processing apparatus 370, imaging apparatus 381, and color luminance meter 382.

The projectors 310-1a to 310-30b, the control device 340, the time server 360, and the information processing apparatus 370 are connected to each other via a network 390.

The projectors 310-1a to 310-30b are disposed above and below the inside of each of the window glass groups 120 attached to a predetermined area on the outer surface of the building 110. As described above, since 30 pieces of window glass are attached to a predetermined area on the outer surface of the building 110, in the present embodiment, 60 projectors are arranged.

The projectors 310-1a to 310-30b execute the first calibration process using the calibration pattern image so that the projection movie or image is projected without distortion in the projection range corresponding to the size of the window glass to be projected. In addition, each of the projectors 310-1a to 310-30b executes the second calibration process using the white image so that the projection movie or image is projected with a predetermined color tint to the window glass to be projected.

In addition, the projectors 310-1a to 310-30b read the specified projection movie or image from the projection movie or images stored in the external memories 320-1a to 320-30b, respectively, based on the projection start instruction from the information processing apparatus 370. Further, the projectors 310-1a to 310-30b project the movie or image for projection read out by the projectors 310-1a to 310-30b onto the electric screen corresponding to the window glass to be projected.

The external memories 320-1a to 320-30b are connected to the projectors 310-1a to 310-30b respectively. The external memories 320-1a to 320-30b store projection movie or images projected by the projectors 310-1a to 310-30b, respectively. The external memories 320-1a to 320-30b include, for example, a USB (Universal Serial Bus) memory and the like.

The electric screens 330-1 to 330-30 are disposed inside the respective window glass groups 120 included in a predetermined area on the outer surface of the building 110. As described above, 30 windows are attached to predetermined areas on the outer surface of the building 110, so 30 electric screens are arranged in this embodiment.

The electric screens 330-1 to 330-30 are connected to the control device 340 via the power supply cable, and the ON state and the OFF state are individually controlled by the control device 340. When the electric screens 330-1 to 330-30 are controlled to be in the ON state by the control device 340, the light transmitting surface of the electric screens 330-1 to 330-30 is in a translucent state by lowering the light transmittance.

The control device 340 turns on the electric screens 330-1 to 330-30 based on the screen ON instruction from the information processing apparatus 370. Further, the control device 340 turns off the electric screens 330-1 to 330-30 based on the screen OFF instruction from the information processing apparatus 370.

Further, the control device 340 turns on the illumination devices 140-1 to 140-6 based on the illumination ON instruction from the information processing apparatus 370. Further, the control device 340 turns OFF the illumination device 140-1-140-6 based on the illumination OFF instruction from the information processing apparatus 370.

The electric appliances 140-1 to 140-6 are connected to the control device 340 via a power supply cable, and the ON state and the OFF state are controlled by the control device 340.

The time server 360 provides time information to the information processing apparatus 370 in order to synchronize the time between the projectors 310-1a to 310-30b and the information processing apparatus 370.

The information processing apparatus 370 is a device for controlling signage processing in the image projection system 300. In the information processing apparatus 370, a proofreading program, an image processing program, and a signage control program are installed. By executing these programs, the information processing apparatus 370 functions as a calibration unit 371, an image processing unit 372, and a signage control unit 373.

The calibration unit 371 executes the first calibration process and the second calibration process together with the projectors 310-1a to 310-30b. Further, the calibration unit 371 executes the first calibration process to calculate correction parameters to be used for generation of projection movie or images projected by the projectors 310-1a to 310-30b, respectively.

Further, the calibration unit 371 calculates the RGB levels to be set in the projectors 310-1a to 310-30b by executing the second calibration process together with the projectors 310-1a to 310-30b.

The image processing unit 372 is an example of a dividing unit. The image processing unit 372 reads the signage target information stored in the signage target information management unit 375 and the image information stored in the image information management unit 376. Further, the image processing unit 372 generates the projection movie or image from the original movie or image provided from the advertiser. The signage target refers to a building 110 in which a large-scale digital signage is realized using the image projection system 300. The signage target information includes information such as the position and size of each window glass of the window glass group 120 included in a predetermined area on the outer surface of the building 110. Further, the image information includes various images used for generation of the projection moving or image, and information for managing correction parameters and the like.

The image processing unit 372 uses the correction parameter calculated by the calibration unit 371 in generating the projection movie or image.

Further, the image processing unit 372 stores the divided still image (details will be described later) generated in the process of generating the projection movie or image in the image information management unit 376. Further, the image processing unit 372 transmits the generated projection movie or images of the group of projection move or images to each of the projectors 310-1a to 310-30b. Accordingly, the projectors 310-1a to 310-30b store the respective projection movie or images in the external memories 320-1a to 320-30b, respectively.

The signage control unit 373 is an example of control unit. The signage control unit 373 performs a signage control process based on the schedule information stored in the schedule information management unit 377. For example, the signage control unit 373 transmits a projection start instruction to each of the projectors 310-1a to 310-30b according to the projection start time. In addition, the signage control unit 373 transmits a screen ON instruction to the electric screens 330-1 to 330-30 according to the projection start time. Furthermore, the signage control unit 373 transmits an illumination OFF instruction to the illumination devices 140-1 to 140-6 according to the projection start time.

When each of the projectors 310-1a to 310-30b executes the first calibration processing, the imaging device 381 photographs the calibration pattern image projected by each of the projectors 310-1a to 310-30b, and transmits the calibration pattern image to the information processing apparatus 370. The imaging device 381 and the information processing apparatus 370 are connected via, for example, a USB cable.

When each of the projectors 310-1a to 310-30b executes the second calibration processing, the color luminance meter 382 measures the color temperature of the white image projected by each of the projectors 310-1a to 310-30b and transmits the measurement result to the information processing apparatus 370. The color luminance meter 382 and the information processing apparatus 370 are connected via a USB cable, for example.

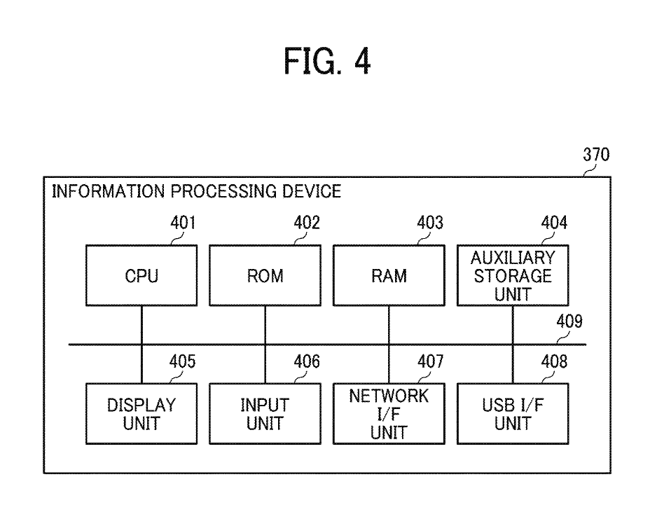

Next, the hardware configuration of the information processing apparatus 370 will be described. FIG. 4 illustrates an example hardware configuration of a piece of information processing apparatus.

As shown in FIG. 4, the information processing apparatus 370 includes CPU (Central Processing Unit) 401, ROM (Read Only Memory) 402, and RAM (Random Access Memory) 403. CPU 401, ROM 402, and RAM 403 form a computer. Further, the information processing apparatus 370 includes the auxiliary storage unit 404, display unit 405, input unit 406, network I/F (interface) unit 407, and USB I/F unit 408. The respective hardware of the information processing apparatus 370 are mutually connected via bus 409.

CPU 401 is a device that executes various programs (for example, a calibration program, an image processing program, a signage control program, etc.) stored in the auxiliary storage unit 404.

ROM 402 is a nonvolatile main storage device. ROM 402 stores various programs, data, and the like necessary for CPU 401 to execute various programs stored in the auxiliary storage unit 404. Specifically, ROM 402 stores a boot program such as Basic Input/Output System (BIOS) and Extensible Firmware Interface (EFI).

RAM 403 is a volatile main storage device such as DRAM (Dynamic Random Access Memory) or SRAM (Static Random Access Memory). RAM 403 provides a work area to be expanded when various programs stored in the auxiliary storage unit 404 are executed by CPU 401.

In an exemplary implementation, CPU 401, in conjunction with any of ROM 402 and RAM 403 may be a general or specific-purpose processor, a digital signal processor (DSP), an ASIC, a field programmable gate array (FPGA) or other programmable logic device (PLD), a discrete gate or transistor logic, discrete hardware components or any other combination for executing functions to realize logic blocks. CPU 401 may include modules, parts, circuits and/or integrated circuits, all of which may be referred to as processing circuitry. The processing circuitry may include a general-purpose processor, and the processing circuitry may include any number of processors, controllers, micro-controllers or state machines. The processing circuitry can also be a combination of computer equipment, such as a combination of a DSP and a micro-processor, a combination of plural micro-processors, or a combination of a DSP and plural micro-processors. The processing circuitry of image processing device 1 may separately or jointly implement each of functionality of the components illustrated in FIG. 4.

The auxiliary storage unit 404 is an auxiliary storage device that stores various programs executed by the CPU 401 and various information used when various programs are executed. Various information stored in the auxiliary storage unit 404 includes signage target information, image information, various information managed by schedule information and image information, correction parameters, and the like. The signage target information management unit 375, the image information management unit 376, and the schedule information management unit 377 are realized by the auxiliary storage unit 404.

The display unit 405 is a display device that displays various screens. The input unit 406 is an input device for inputting various information to the information processing apparatus 370. The network I/F unit 407 is an interface device for connecting to the network 390. The information processing apparatus 370 performs communication with the projectors 310-1a to 310-30b, the control device 340, and the time server 360 via the network I/F unit 407.

The USB I/F unit 408 is an interface device for connecting a USB cable. The information processing apparatus 370 transmits and receives data to and from the imaging device 381 and the color luminance meter 382 via the USB I/F unit 408.

Next, various kinds of information (signage target information, image information, schedule information) stored in each management unit (signage target information management unit 375, image information management unit 376, schedule information management unit 377) of the information processing apparatus 370.

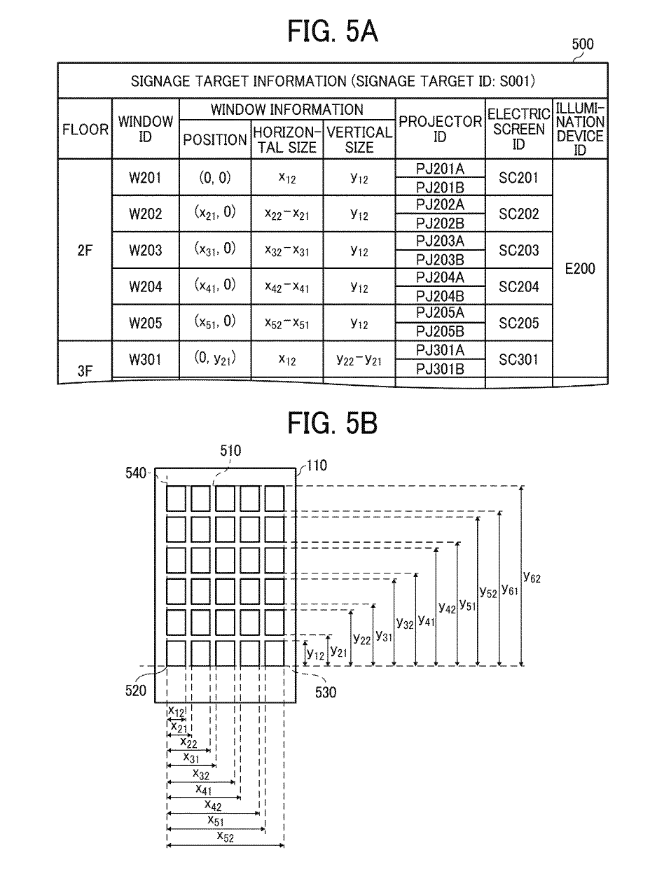

First, the signage target information stored in the signage target information management unit 375 will be described. FIG. 5A is a diagram showing an example of signage target information. As shown in FIG. 5A, the signage target information 500 is generated for each signage target. In the present embodiment, the signage target ID of the building 110 is “S 001”.

As shown in FIG. 5A, “floor”, “window ID”, “window information”, “projector ID”, “electric screen ID”, and “Illumination device ID” are included in the signage target information 500.

A floor number is stored in the “Floor”. The floor number indicates a floor to which the window glass group 120 included in a predetermined area on the outer surface of the building 110 is attached.

In the “window ID”, an identifier for identifying each window glass of the window glass group 120 included in a predetermined area on the outer surface of the building 110 is stored.

In the “window information”, “position”, “horizontal size”, and “vertical size” are stored. Here, with reference to FIG. 5B, “position”, “horizontal size” and “vertical size” of each window glass stored in “window information” will be described.

As shown in FIG. 5B, the image projection system 300 realizes a large-scale digital signage using a predetermined area 510 on the outer surface of the building 110. At this time, the image projection system 300 defines the reference point (origin) and the reference axis (x axis, y axis) when specifying the layout of each window glass included in the predetermined region 510.

In FIG. 5B, the point 520 indicates the origin in the predetermined region 510. In addition, the axis 530 indicates the x-axis when the point 520 is the origin in the predetermined region 510, and the axis 540 indicates the y-axis when the point 520 is the origin in the predetermined region 510.

As shown in FIG. 5B, by defining the predetermined area 510, the origin 520, the x axis 530, and the y axis 540, the layout (position, horizontal size, vertical size) of each windowpane is uniquely specified.

Return to the explanation of FIG. 5A. In the “position”, coordinates indicating the position of the lower left corner of each windowpane in the predetermined area 510 on the outer surface of the building 110 are stored. In the case of FIG. 5A, the coordinates of the lower left corner position of the window glass with the window ID=“W 201” is the origin (0, 0).

In the “horizontal size”, the horizontal length (width) of each window glass is stored. For example, in the case of a window glass with window ID=“W201”, the coordinates of the position of the lower left corner is (0, 0) and the coordinates of the position of the lower right corner is (x 12, 0). Therefore, the horizontal size=“x 12”. In the case of the window glass with the window ID=“W202”, the coordinates of the position of the lower left corner is (x21, 0) and the coordinates of the position of the lower right corner is (x22, 0). Therefore, the horizontal size=“x 22−x 21”.

In the “vertical size”, the vertical length (height) of each window glass is stored. For example, in the case of a window glass with window ID=“W201”, the coordinates of the position of the lower left corner is (0, 0) and the coordinates of the position of the upper left corner is (0, y 12). Therefore, the vertical size=“y 12”. In the case of the window glass with the window ID=“W301”, the coordinates of the position of the lower left corner is (0, y21) and the coordinates of the position of the upper left corner is (0, y22). Therefore, the vertical size=“y22−y21”.

In the “projector ID”, an identifier for identifying a projector arranged at a position corresponding to each window glass is stored. In the example of FIG. 5A, projectors identified by projector IDs=“PJ201A” and “PJ201B” are arranged at positions corresponding to the window glass identified by the window ID=“W201” Respectively.

In the “electric screen ID”, an identifier for identifying the electric screen arranged at the position corresponding to each window glass is stored. In the example of FIG. 5A, at the position corresponding to the window glass identified by the window ID=“W201”, it indicates that the electric screen identified by the electric screen ID=“SC201” is arranged.

In the “illumination device ID”, an identifier for identifying the illumination device arranged at a position corresponding to any window glass on each floor is stored. In the example of FIG. 5A, on the floor identified by the floor=“2 F”, it is indicated that the illumination device identified by the illumination device ID=“E 200” is arranged.

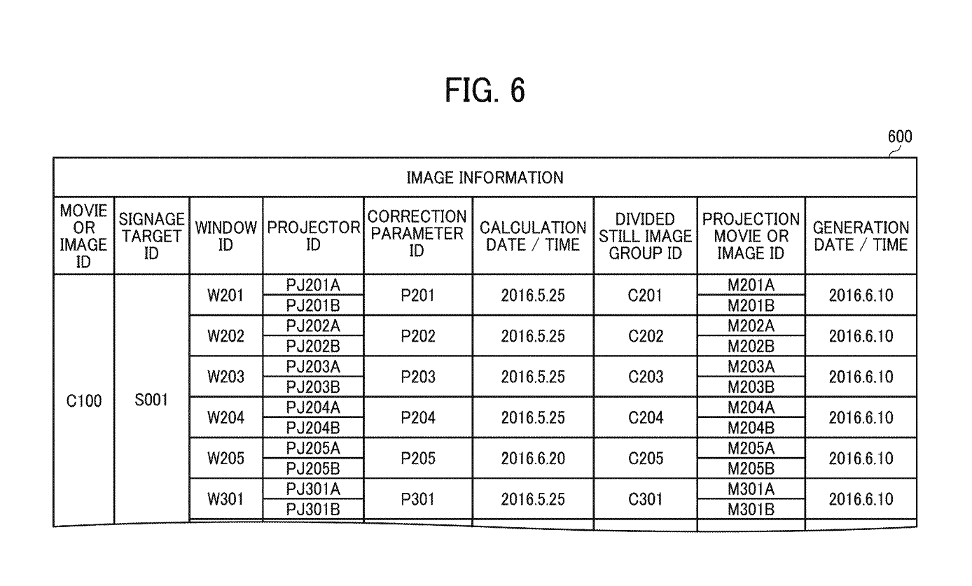

Next, the image information stored in the image information management unit 376 will be described. FIG. 6 is a diagram showing an example of image information. As shown in FIG. 6, the image information 600 includes “movie or image ID”, “signage target ID”, “window ID”, and “projector ID” as items of information. Also, the image information 600 includes “correction parameter ID”, “calculation date/time”, “divided still image group ID”, “projection movie or image ID”, and “generation date/time” as items of information.

In the “movie or image ID”, an identifier for identifying the original movie or image provided from the advertiser is stored. In the example of FIG. 6, the movie or image identified by “C100” as the movie or image ID is stored in the image information management unit 376.

As the “signage target ID”, an identifier for identifying the building 110 is stored. The building 110 realizes a large scale digital signage using the projection movie or image group 130 generated based on the original movie or image provided from the advertiser. The example in FIG. 6 shows that large-scale digital signage, by using the projection movie or image group 130 generated based on the movie or image identified by the movie or image ID=“C100”, is realized in the building 110 identified by the signage target ID=“S 001” In the “window ID”, an identifier for identifying each window glass of the window glass group 120 included in the predetermined area 510 on the outer surface of the building 110 identified by the signage target ID=“S001” is stored.

In the “projector ID”, an identifier for identifying a projector arranged at a position corresponding to each window glass identified by the window ID is stored.

In the “correction parameter ID”, an identifier for identifying the correction parameter calculated by the calibration unit 371 is stored. As described above, as the first calibration process is executed, the correction parameter ID is stored in association with the window ID in the calibration unit 371 in order to calculate the correction parameter for each windowpane. In the “calculation date and time”, the date and time when the correction parameter was calculated is stored.

In the “divided still image group ID”, an identifier for identifying a divided still image group is stored. The divided still image group is generated in the process of generating a projection movie or image group based on the movie or image identified by movie or image ID=“C100”.

In the “movie or image ID for projection”, an identifier for identifying each projection movie or image included in the projection movie or image group generated based on the movie or image identified by the movie or image ID=“C100” is stored.

In “generation date and time”, the date and time at which each projection movie or image identified by the projection movie or image ID was generated is stored.

In the example of FIG. 6, projection movie or image ID=“M201A”, “M201B” . . . are generated from a movie or image with movie or image ID=“C100”.

Further, according to the example of FIG. 6, the projecting movie or image with the projecting movie or image ID=“M 201 A” is projected by the projector with the projector ID=“PJ 201 A” placed at the position corresponding to the window glass with the window ID=“W 201”.

Further, according to the example of FIG. 6, when the projection movie or image with projection movie or image ID=“M201A” is generated, the correction parameter (correction parameter ID=“P201”) is calculated at “May 25, 2016”.

Further, according to the example of FIG. 6, the divided still image group of the divided still image group ID=“C 201” is corrected by the correction parameter (correction parameter ID=“P 201”). Further, according to the example of FIG. 6, based on the corrected divided still image group with ID=“C 201”, the projection movie or image ID=“M 201 A” and “M201 B” are generated on Jun. 10, 2016.

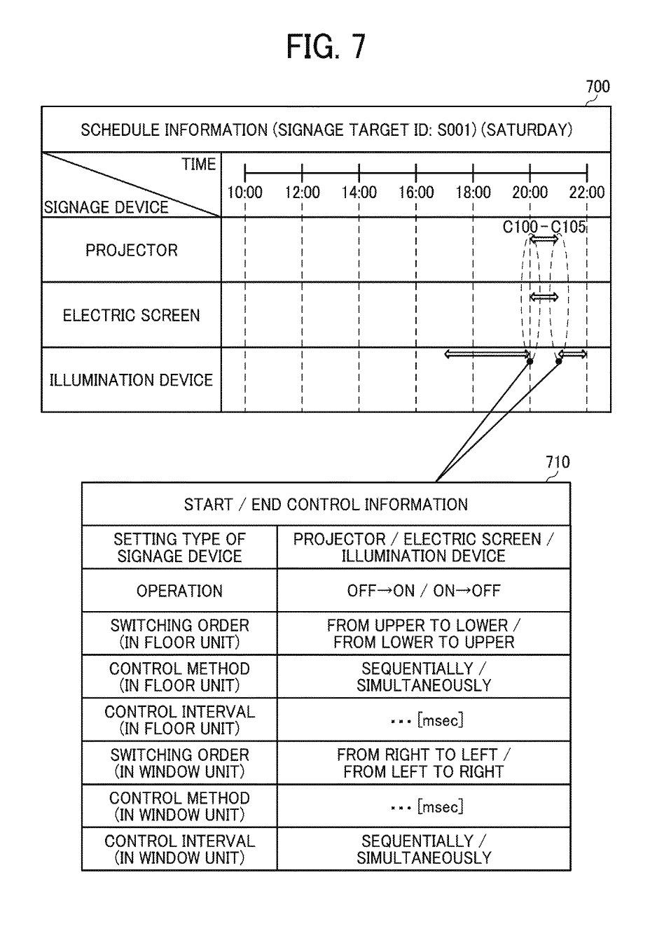

Next, the schedule information stored in the schedule information management unit 377 will be described. FIG. 7 is a diagram showing an example of the schedule information. As shown in FIG. 7, the schedule information 700 is generated for each signage target and for each day of the week. Further, as shown in FIG. 7, the schedule information 700 includes “time” and “signage device” as items of information.

In “Time”, a time zone in which the window glass group 120 of the building 110 identified by the signage target ID=“S 001” can be used as a digital signage is stored. According to the example of FIG. 7, it is possible to use the window glass group 120 as a digital signage in the time zone between 10:00 and 22:00 on the day of the week=“Saturday”.

“Signage device” further includes “projector”, “electric screen”, and “illumination device”. Projector “stores the time period during which the projection movie or image is projected by the projectors 310-a to 310-30b. According to the example of FIG. 7, a group of projection movie or images generated based on movie or image ID=“C 100” to “C 105” is projected between 20:00 and 21:00.

The “electric screen” stores the time period during which the electric screens 330-1 to 330-30 are in the ON state. The time period during which the electric screens 330-1 to 330-30 are in the ON state is the same time period as the time period (20:00 to 21:00) in which the projection movie or image group is projected by the projectors 310-1a to 310-30b.

In the “illumination device”, the time zone during which the illumination device 140-1 to 140-6 are in the ON state is stored. In the present embodiment, the illumination device 140-1 to 140-6 are in the ON state after the evening (in the example of FIG. 7, after 16:30). However, the time period during which the projection movie or image is projected by the projectors 310-1a to 310-30b (between 20:00 and 21:00) is excluded.

Detailed operations of each signage device at the start of projection and end of projection for the projection movie or image by the projectors 310-1a to 310-30b are specified separately as start control information and end control information.

The table 710 shows setting items of the start control information and the end control information defining the detailed operation of each signage device at the time of projection start and projection end. As shown in the table 710, “setting type of signage device”, “operation”, “switching order (in floor unit)”, and “control method (in floor unit)” are included in the setting items of the start control information and the end control information. Further, the setting items of the start control information and the end control information include “switching order (in window unit)”, “control method (in window unit)”, and “control interval (in window unit)”.

The setting contents set to each setting item shown in the table 710 and the detailed operation of each signage device when each setting content is set will be described later.

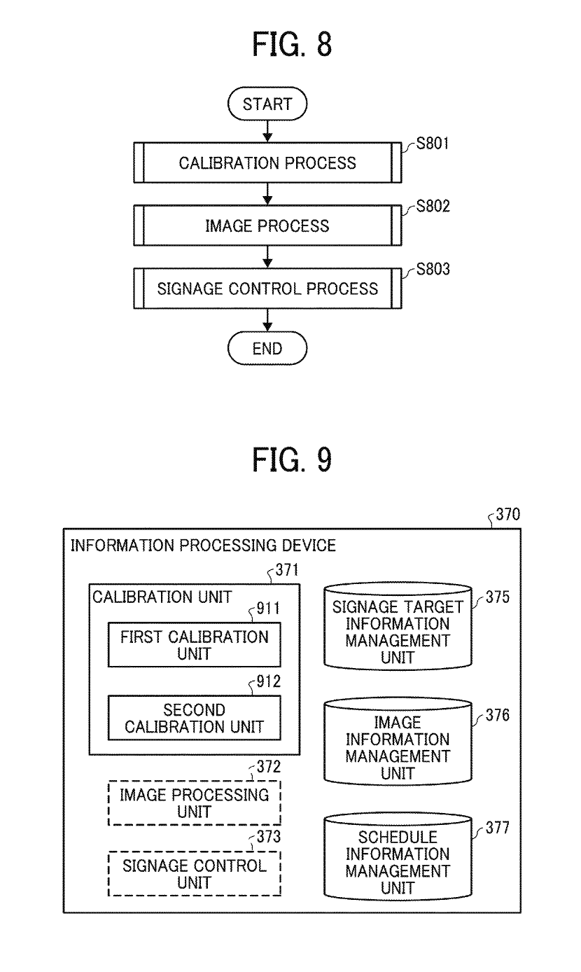

Next, the flow of the signage process in the image projection system 300 will be described. FIG. 8 is a flowchart showing the flow of the signage process. When installation of the image projection system 300 is completed in the building 110, the image projection system 300 executes the signage process shown in FIG. 8.

Specifically, in step S801, the image projection system 300 performs calibration processing (first calibration processing, second calibration processing, and the like) of the projectors 310-1a to 310-30b.

In step S802, the image projection system 300 performs image processing (creation of projection movie or images (“M 201 A” to “M 705 B”) and transmission of projection movie or images to the projectors 310-1a to 310-30 b).

In step S803, the image projection system 300 performs a signage control process. Specifically, the image projection system 300 controls the projection start/end control of the projection movie or image group by the projectors 310-1a to 310-30b, controls the ON/OFF of the electric screens 330-1 to 330-30, and controls the ON/OFF of the illumination devices 140-1 to 140-6.

Next, details of the calibration process (step S801) in the image projection system 300 will be described.

First, the functional configuration of the calibration unit 371 of the information processing apparatus 370 for executing the proofreading process will be described. FIG. 9 illustrates an example functional configuration of the calibration part of the information processing apparatus.

As shown in FIG. 9, the calibration unit 371 includes a first calibration unit 911 and a second calibration unit 912. When the first calibration processing, the first calibration unit 911 is activated and executes various processes. Specifically, the first calibration unit 911 calculates correction parameters used by the image processing unit 372 to generate a projection movie or image. In addition, the first calibration unit 911 stores the calculated correction parameter in the image information management unit 376, and stores the correction parameter ID indicating the calculated correction parameter and calculation date and time in the image information 600 in association with the window ID. As a result, the image processing unit 372 generates a projection movie or image without distortion when projected by the projectors 310-1a to 310-30b.

When the second calibration process, the second calibration unit 912 is activated and executes various processes. Specifically, the second calibration unit 912 calculates the RGB level so that the projection movie or image is projected with a predetermined color, and sets the RGB level for the projectors 310-1a to 310-30b.

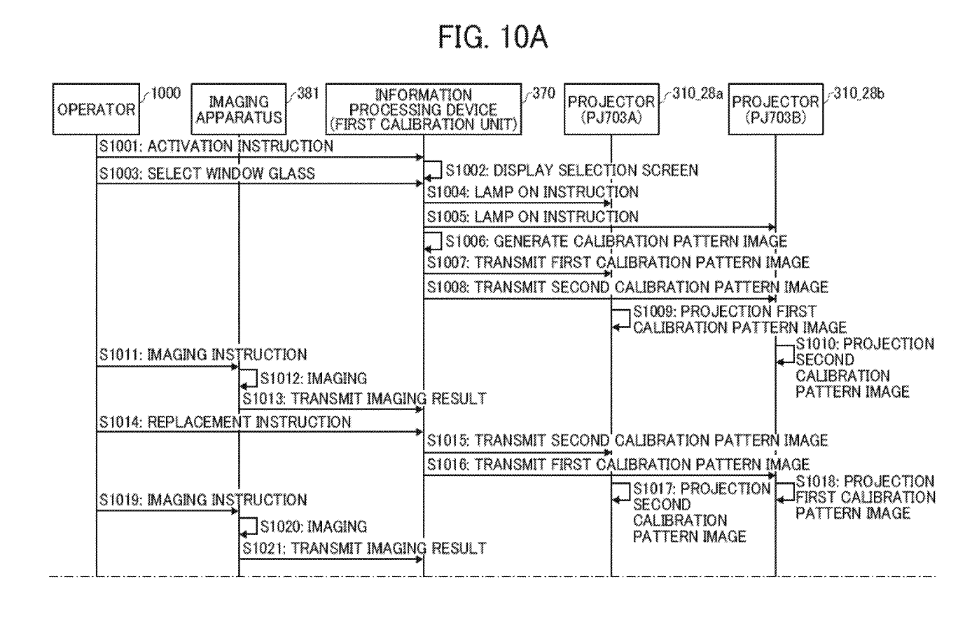

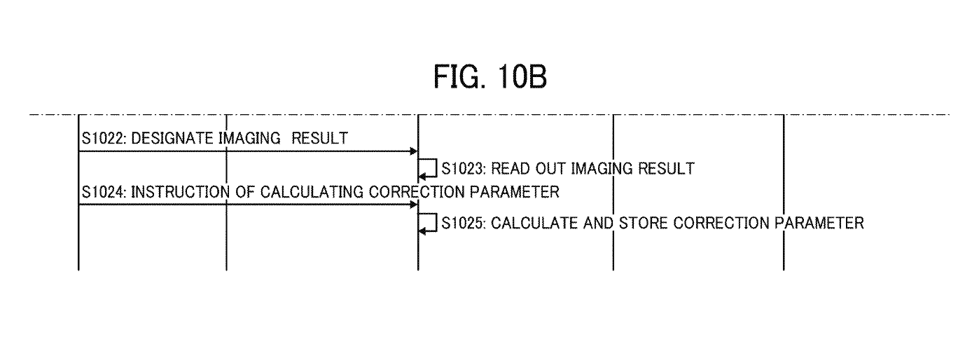

Next, details of the first calibration process will be described with reference to FIGS. 11 to 13 and FIGS. 10A and 10B. FIGS. 10A and 10B is a sequence diagram of the first calibration process.

As shown in FIG. 10A, in step S1001, the operator 1000 inputs an activation instruction for activating the first calibration unit 911 to the information processing apparatus 370.

Next, the fault detector 151 of the equipment 10 detects a fault that has occurred in the equipment 10 (S707).

In response to input of an activation instruction by the operator 1000, the first calibration unit 911 is activated in step S1002, and the display unit 405 of the information processing apparatus 370 is provided with a target (projector) to be selected by the operator 1000 is displayed.

In response to input of the activation instruction by the operator 1000, the first calibration unit 911 is activated in step S1002, and a screen is displayed on the display unit 405 of the information processing apparatus 370. The screen displayed on the display unit 405 is a selection screen for the operator 1000 to select the object (projector) for executing the first calibration process.

In step S1003, the operator 1000 selects the window glass on which the object to be subjected to the first calibration process is arranged from among the selection screens displayed on the display unit 405.

In response to the window glass being selected by the operator 1000, the first calibration unit 911 identifies the projector located at the position corresponding to the selected window glass. In steps S1004 and S1005, the first calibration unit 911 transmits a lamp ON instruction to each of the identified projectors.

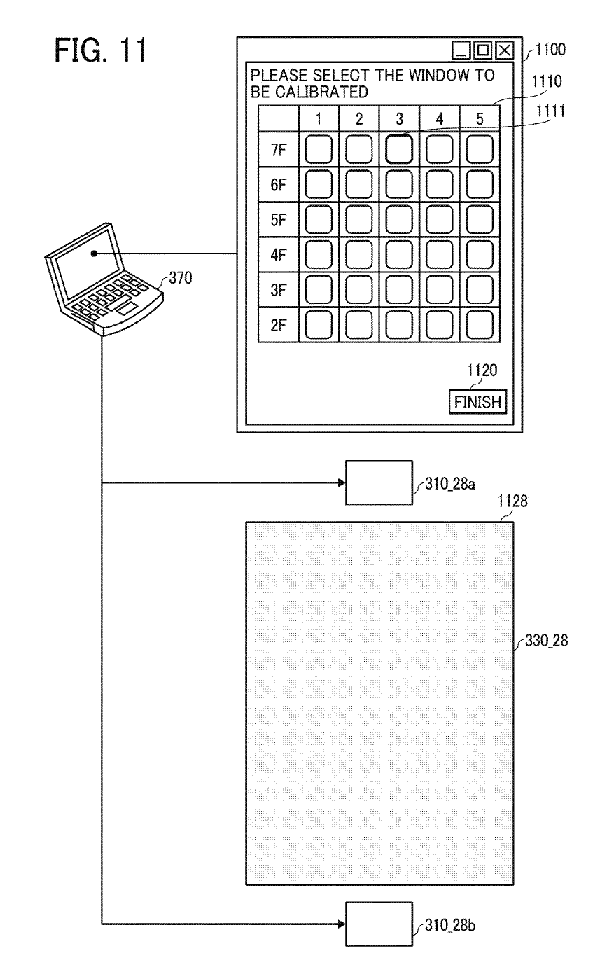

FIG. 11 is a diagram showing an example of the screen of the information processing apparatus displayed at the time of the first calibration processing. When the first calibration unit 911 is activated, a selection screen 1100 is displayed on the display unit 405 of the information processing apparatus 370. As shown in FIG. 11, the selection screen 1100 includes the layout 1110 of the window glass group 120 of the building 110.

The operator 1000 presses a rectangular button indicating the window glass in the layout 1110 and presses the completion button 1120 so as to select the window glass on which the object to be subjected to the first calibration process is disposed. The example in FIG. 11 shows a state in which the rectangular button 1111 is pressed and the completion button 1120 is pressed.

The window glass specified by the rectangular button 1111 is the window glass 1128 with the window ID=“W 703”. As shown in the lower part of FIG. 11, a projector 310-28a (projector ID=“PJ 703 A”) and a projector 310-28b (projector ID=“PJ 703 B”) are arranged at positions corresponding to the window glass 1128.

Accordingly, in step S1004, the first calibration unit 911 transmits a lamp ON instruction to the projector 310-28a. In step S1005, the first calibration unit 911 transmits a lamp ON instruction to the projector 310-28b. At this time, it is assumed that the electric screen 330-28 (electric screen ID=“SC 703”) of the window glass 1128 is in the ON state.

Subsequently, in step S1006, the first calibration unit 911 generates a calibration pattern image. The first calibration unit 911 generates two different calibration pattern images as calibration pattern images.

In step S1007, the first calibration unit 911 transmits the first calibration pattern image to the projector 310-28a. In step S1008, the first calibration unit 911 transmits the second calibration pattern image to the projector 310-28b.

In step S1009, the projector 310-28a projects the first calibration pattern image transmitted from the first calibration unit 911. In step S1010, the projector 310-28b projects the second calibration pattern image transmitted from the first calibration unit 911.

In step S1011, the operator 1000 inputs an imaging instruction to the imaging device 381 so as to photograph the projected first and second calibration pattern images using the imaging device 381.

In step S1012, the imaging device 381 executes imaging processing on the projected first and second calibration pattern images, and in step S1013, the imaging device 381 transmits the imaging result to the information processing apparatus 370.

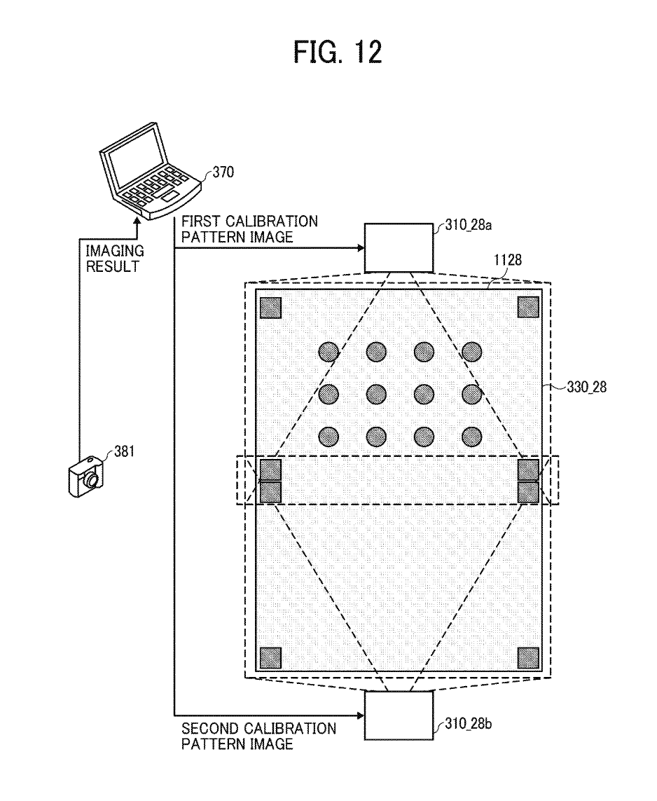

FIG. 12 is a view showing an example of a calibration pattern image projected during the first calibration process. As shown in FIG. 12, the projector 310-28a projects the first calibration pattern image, and the projector 310-28b projects the second calibration pattern image. The operator 1000 photographs the projected first and second calibration pattern images using the imaging device 381, thereby transmitting the imaging result to the information processing apparatus 370.

In step S1014, the operator 1000 inputs a replacement instruction for replacement the first calibration pattern image and the second calibration pattern image.

In step S1015, the first calibration unit 911 transmits the second calibration pattern image to the projector 310-28a according to the replacement instruction. In step S1016, the first calibration unit 911 transmits the first calibration pattern image to the projector 310-28b.

In step S1017, the projector 310-28a projects the second calibration pattern image transmitted from the first calibration unit 911. In step S1018, the projector 310-28b projects the first calibration pattern image transmitted from the first calibration unit 911.

In step S1019, the operator 1000 inputs an imaging instruction to the imaging device 381 so as to photograph the projected second and first calibration pattern images using the imaging device 381.

In step S1020, the imaging device 381 executes imaging processing on the projected second and first calibration pattern images, and in step S1021, the imaging device 381 transmits the imaging result to the information processing apparatus 370.

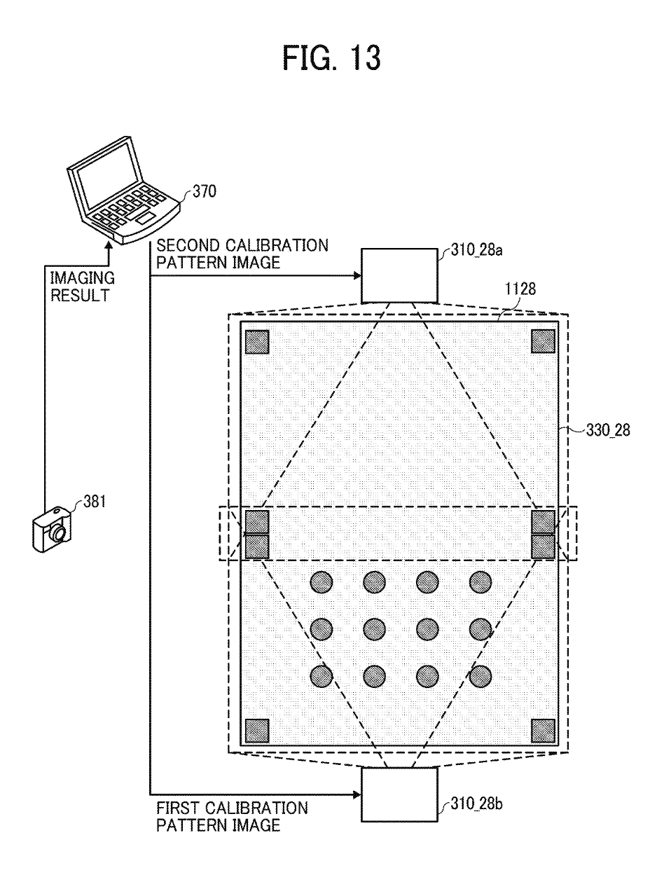

FIG. 13 is a diagram showing another example of the calibration pattern image projected during the first calibration process. As shown in FIG. 13, the projector 310-28a projects the second calibration pattern image, and the projector 310-28b projects the first calibration pattern image. The operator 1000 photographs the projected second and first calibration pattern images using the imaging device 381, thereby transmitting the imaging result to the information processing device 370.

In step S1022, the operator 1000 inputs to the first calibration unit 911 to designate the imaging result used for calculating the correction parameter. In step S1023, the first calibration unit 911 reads the imaging result designated by the operator 1000.

In step S1024, the operator 1000 makes an input for instructing the calculation of the correction parameter. In step S1025, the first calibration unit 911 calculates a correction parameter based on the read imaging result.

In the correction parameters calculated by the first calibration unit 911, geometrical parameters for performing various geometrical corrections such as alignment correction, scale alignment correction, and distortion correction on the first and second calibration pattern images are included. This geometrical parameter varies depending on various factors such as, for example, the installation position of the electric screen or the projection device, and the individual difference of the optical device of the projection device. For this reason, the geometric parameters often differ depending on the window glass (the combination of the electric screen and the projection device). The image processing unit 372, which will be described later, performs correction using appropriate geometric parameters for each window glass to avoid occurrence of problem such as a part of the projection movie or images in the projection movie or image group 130 projected as shown in FIG. 1 is distorted and displayed.

The first calibration unit 911 stores the calculated correction parameter in the image information management unit 376. Further, the first calibration unit 911 stores the correction parameter ID (for example, “P 703”) and the calculated date (for example, “2016 May 25”) in association with the window ID (for example, “W 703”) in the image information 600.

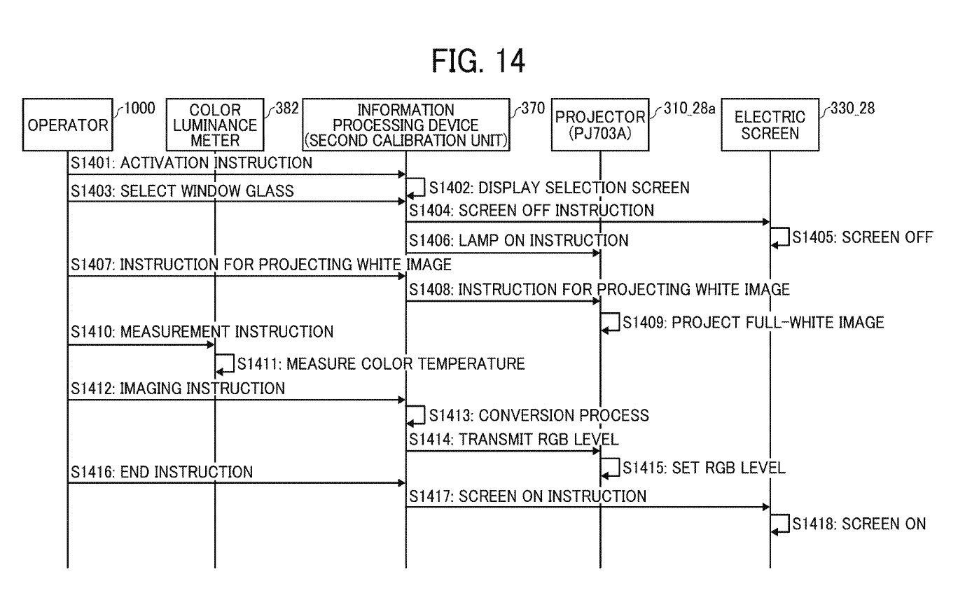

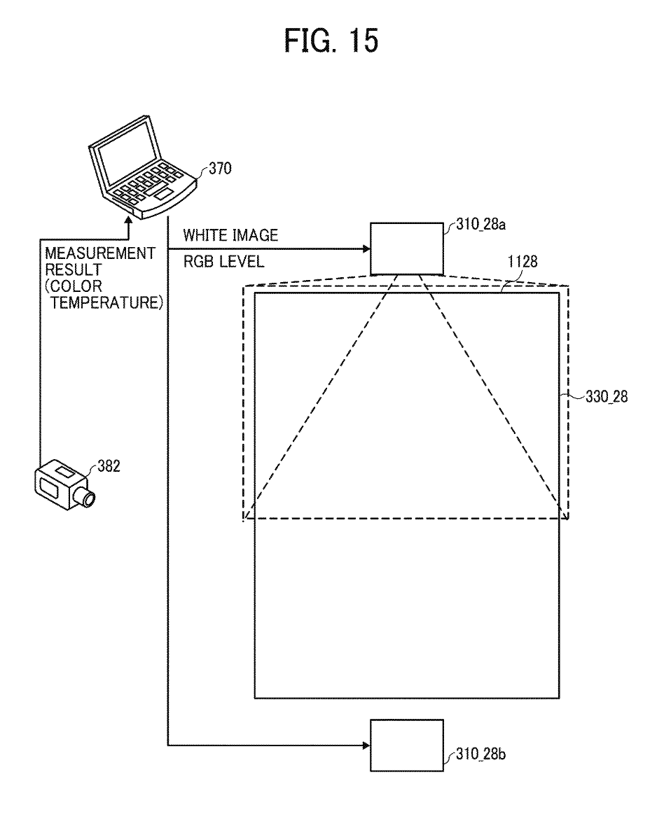

Next, the details of the second calibration process will be described with reference to the sequence diagram of FIGS. 14 and 15.

FIG. 14 illustrates a sequence diagram including steps in a second calibration process. As shown in FIG. 14, in step S1401, the operator 1000 inputs an activation instruction for activating the second calibration unit 912 to the information processing device 370.

In response to input of the activation instruction by the operator 1000, the second calibration unit 912 is activated in step S1402, and the display unit 405 of the information processing device 370 is provided with a target (projector) to be selected by the operator 1000 is displayed.

In step S1403, the operator 1000 selects a window glass on which the object to be subjected to the second calibration process is arranged from among the selection screens displayed on the display unit 405.

In response to the selection of the window glass by the operator 1000, the second calibration unit 912 identifies the electric screen arranged at the position corresponding to the selected window glass. In step S1404, the second calibration unit 912 transmits a screen OFF instruction to the identified electric screen.

In the example of FIG. 14, similarly to the first calibration process, the window glass 1128 with the window ID=“W 703” is selected and the screen OFF instruction is transmitted to the corresponding electric screen 330-28.

In response to the transmission of the screen OFF instruction from the second calibration unit 912, the electric screen 330-28 is turned off in step S1405.

In step S1406, the second calibration unit 912 transmits a lamp ON instruction to the projector 310-28a (projector ID=“PJ 703 A”) arranged at a position corresponding to the window glass 1128 with the window ID=“W 703”. As a result, the lamp of the projector 310-28a is turned on.

In step S11407, the operator 1000 inputs a projection instruction to the information processing device 370 to project the white image to the projector 310-28a.

In step S1408, the second calibration unit 912 transmits a white image projection instruction to the projector 310-28a in response to the white image projection instruction from the operator 1000.

In step S1409, the projector 310-28a performs full-white projection according to the white image projection instruction transmitted from the second calibration unit 912.

In step S1410, the operator 1000 inputs a measurement instruction to the color luminance meter 382 to measure the color temperature of the window glass performed full-whit projection by the projector 310-28a.

In step S1411, the color luminance meter 382 measures the color temperature of the window glass 1128 performed full-white projection. In step S1412, the operator 1000 inputs the measured color temperature to the information processing device 370 as a measurement result.

In step S1413, the second calibration unit 912 performs conversion processing for converting the color temperature input by the operator 1000 to the RGB level.

In step S1414, the second calibration unit 912 transmits the RGB level calculated by performing the conversion process to the projector 310-28a.

In step S1415, the projector 310-28a sets the RGB level transmitted from the second calibration unit 912.

FIG. 15 illustrates an example of a white image projected during the second calibration process. As shown in FIG. 15, when the electric screen 330-28 is in the OFF state, the projector 310-28a projects the white image onto the window glass 1128. In addition, the operator 1000 measures the color temperature of the window glass 1128 using the color luminance meter 382, and inputs the measurement result to the information processing device 370. As a result, the information processing device 370 calculates the RGB level, and the RGB level corresponding to the measurement result is set in the projector 310-28a.

Returning to the description of FIG. 14. In step S1416, the operator 1000 inputs an instruction to end the second calibration process to the information processing device 370. In step S1417, the second calibration unit 912 transmits a screen ON instruction to the electric screen 330-28 in response to the input of an end instruction by the operator 1000.

In response to the transmission of the screen ON instruction from the second calibration unit 912, the electric screen 330-28 is turned on in step S1418.

Next, the details of the image processing (step S802) in the image projection system 300 will be described.

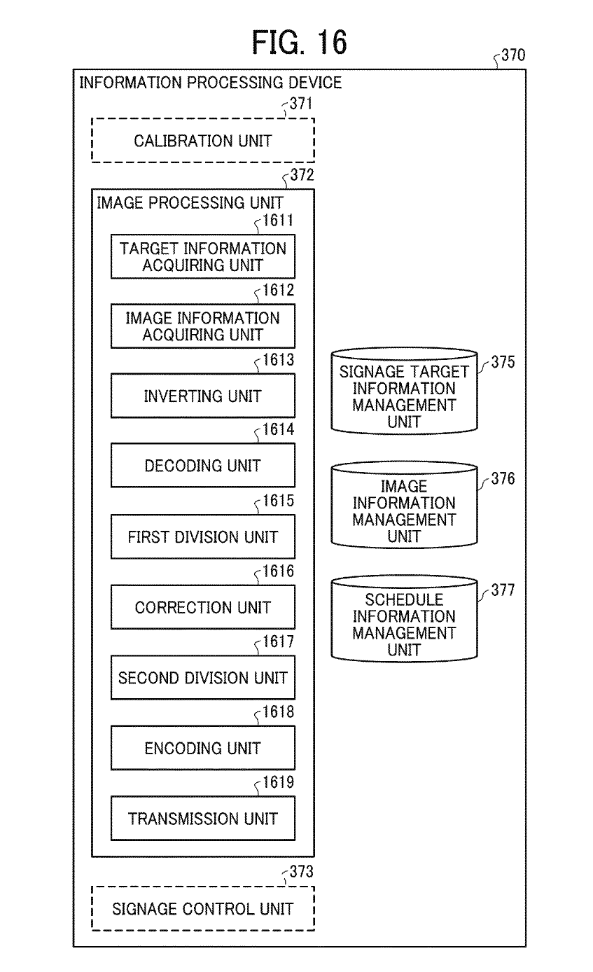

First, the functional configuration of the image processing unit 372 of the information processing device 370 that executes image processing will be described. FIG. 16 is a diagram showing a functional configuration of an image processing unit of the information processing apparatus.

As shown in FIG. 16, the image processing unit 372 includes a target information acquiring unit 1611, an image information acquiring unit 1612, an inverting unit 1613, and a decoding unit 1614. Further, the image processing unit 372 includes a first division unit 1615, a correction unit 1616, a second division unit 1617, an encoding unit 1618, and a transmission unit 1619.

The target information acquisition unit 1611 reads the signage target information from the signage target information management unit 375 and notifies the first division unit 1615.

The image information acquiring unit 1612 reads the movie or image provided from the advertiser from the image information management unit 376, and notifies the inverting unit 1613.

The inverting unit 1613 inverts the left and right of the movie or image notified from the image information acquiring unit 1612. In the image projection system 300, a movie or image is projected from the inside of a transparent or translucent light transmitting surface (a window glass and an electric screen), and the projection result of the movie or image is visually recognized from the outside of a transparent or translucent light transmitting surface (a window glass and an electric screen). Therefore, it is necessary to invert left and right in advance. In this way, by performing the inverting process by the inverting unit 1613, it is possible to avoid a situation where a movie or image in which the left and right are inverted from the movie or image intended by the advertiser is viewed. The inverting unit 1613 notifies the decoded unit 1614 of the inverting movie or image.

The decoding unit 1614, by decoding the movie or image for which the left and right inverted and decomposing it into frame units, extracts a still image group. The decoding unit 1614 sequentially notifies the still images included in the extracted still image group to the first division unit 1615.

The first division unit 1615 performs a first division process for dividing each still image notified from the decoding unit 1614 into a plurality of still images based on the signage target information 500 notified from the target information acquisition unit 1611. As a result, the first division unit 1615 generates divided still images (divided images) according to the position of the window glass and the size of the window glass.

The first dividing unit 1615 generates, by dividing the plurality of divided still images acquired by performing the first division processing on all the still images included in the still image group for each divided still image of the same window glass, a plurality of divided still image groups corresponding to the number of window glasses. The first division unit 1615 stores the generated plurality of divided still image groups in the image information management unit 376.

In addition, the first division unit 1615 adds the divided still image group ID to each of the generated plurality of divided still image groups, and stores them in the image information 600 in association with the window ID.

Further, the first division unit 1615 notifies the correction unit 1616 in association with each of the generated plurality of divided still image groups with the window ID.

The correction unit 1616 corrects each of the plurality of divided still image groups notified from the first division unit 1615 by using correction parameters corresponding to the window ID. In addition, the correction unit 1616 notifies the second division unit 1617 of the corrected plurality of divided still image groups.

The second division unit 1617 divides each of the corrected plurality of divided still image groups notified by the correction unit 1616 into projector units. Since the plurality of corrected divided still image groups notified by the correcting unit 1616 are generated for each window glass, the second dividing unit 1617 divides the divided still image groups into projector units.

The encoding unit 1618 encodes each plurality of corrected divided still image groups divided into projector units and generate a plurality of projection movies or images for the number of projectors. The encoding unit 1618 stores the projection movie or image ID for identifying the generated plurality of projection movies or images and the generation date and time in the image information 600 in association with the projector ID.

The transmission unit 1619 transmits the plurality of projection movies or images generated by the encoding unit 1618 to the corresponding projectors. Note that by sending the projecting movie or image to the corresponding projector in advance by the transmitting unit 1619, the signage control unit 373 only has to send a projection start instruction to the projectors at the start of projection. This makes it possible to reduce the possibility of occurrence of a delay in projection of the projection movie or image, as compared with the case where the projecting movie or image is transmitted to the projector at the start of projection.

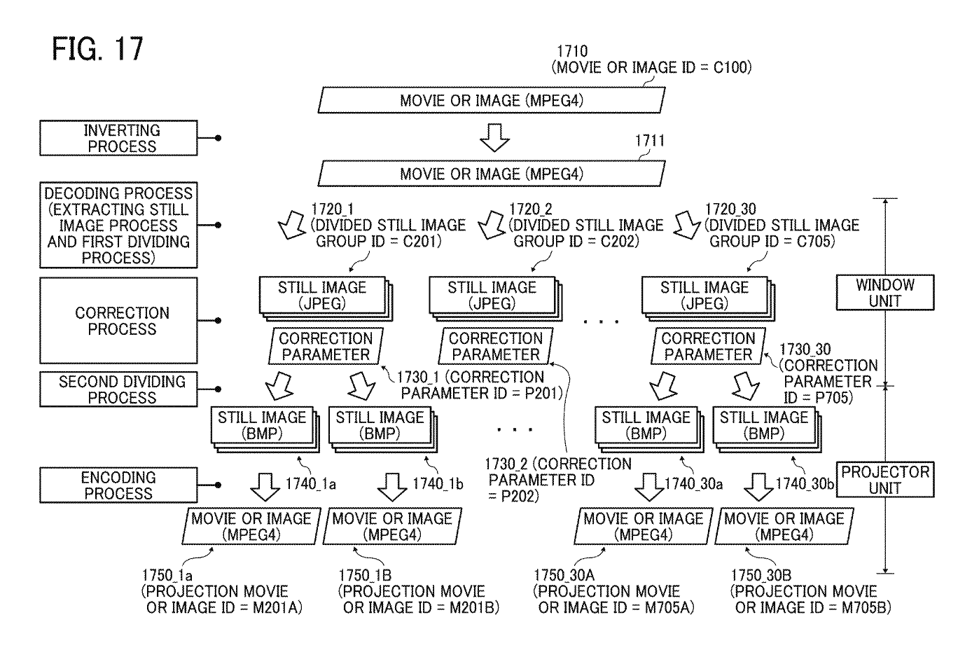

Next, a specific example of image processing by the image processing unit 372 will be described. FIG. 17 is a diagram showing a specific example of image processing.

In FIG. 17, the movie or image 1710 is a movie or image with a movie or image ID=“C 100” provided from the advertiser and stored in the image information managing unit 376 in the MPEG 4 format. When the image information acquiring unit 1612 reads the movie or image 1710 and notifies the inverting unit 1613, the inverting unit 1613 inverts the left and right of the movie or image 1710 and generates the inverted movie or image 1711.

The inverted movie or image 1711 is decoded by the decoding unit 1614 and extracted as a still image group including a plurality of still images. Further, for the extracted still image group, the first division unit 1615 performs a first division process based on the signage target information 500 and generates a plurality of divided still image groups.

It is to be noted that respectively the plurality of divided still image groups (the divided still image groups 1720-1, 1720-2 . . . 1720-30) are assigned to the divided still image group IDs (C 201, C 202 . . . C 705) and are stored in the image information 600 in association with the window ID.

Further, for each the plurality of divided still image groups 1720-1, 1720-2 . . . 1720-30, the correction unit 1616 corrects using the corresponding correction parameter. For example, the correction unit 1616 corrects the divided still image group 1720-1 by using the correction parameter 1730-1 (correction parameter ID=“P 201”). In addition, the correction unit 1616 corrects the divided still image group 1720-2 by using the correction parameter 1730-2 (correction parameter ID=“P 202”). Further, the correcting unit 1616 corrects the divided still image group 1720-30 by using the correction parameter 1730-30 (correction parameter ID=“P 705”).

The corrected divided still image groups 1720-1, 1720-2 . . . 1720-30 corrected by the correction parameters are divided into projector units by the second division unit 1617. For example, the corrected divided still image group 1720-1 is divided into a divided still image group 1740-1a for the projector 310-1a and a divided still image group 1740-1b for the projector 310-1b.

Similarly, the corrected divided still image group 1720-30 is divided into a divided still image group 1740-30a for the projector 310-30a and a divided still image group 1740-30b for the projector 310-30b.

The corrected divided still image groups 1740-1a to 1740-30b divided into projector units by the second division unit 1617 are encoded by the encoding unit 1618. As a result, the encoding unit 1618 generates a movie or image for projection in the MPEG 4 format.

For example, the encoding unit 1618 generates a projection movie or image 1750-1a by encoding the divided still image group 1740-1a for the projector 310-1a. Further, the encoding unit 1618 generates the projection movie or image 1750-1b by encoding the divided still image group 1740-1b for the projector 310-1 b. Furthermore, the encoding unit 1618 generates, by encoding the divided still image group 1740-30a for the projector 310-30a and the divided still image group 1740-30b for the projector 310-30b, projection movie or images 1750-30a and 1750-30b.

The encoding unit 1618 stores, in the image information 600, the projection movie or image ID (M201A, M201B . . . M705A, M705B) for identifying the generated plurality of projection movie or images 1750-1a to 1750-30b and the generation date and time in association with the projector ID.

Further, the transmitting unit 1619 transmits the generated plurality of projection movie or images 1750-1a to 1750-30b to the corresponding projectors. For example, the transmission unit 1619 transmits the projection movie or image 1750-1a to the projector 310-1a. Also, the projection movie or image 1750-1b is transmitted to the projector 310-1b. Furthermore, the transmission unit 1619 transmits the projection movie or image 1750-30a to the projector 310-30a, the projection movie or image 1750-30b to the projector 310-30b, respectively.

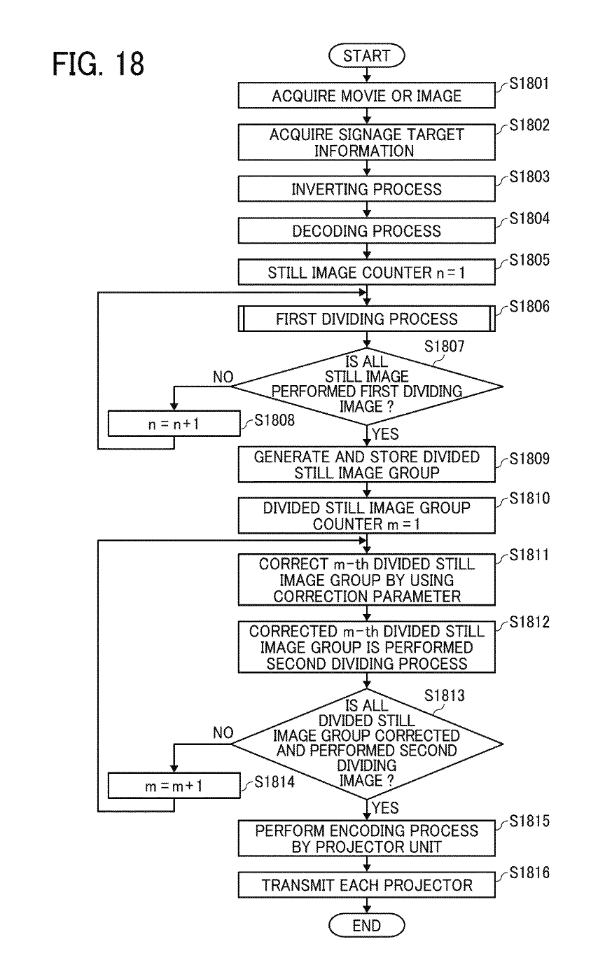

Next, the flow of image processing will be described with reference to the flowchart of FIG. 18. FIG. 18 is a flowchart showing the flow of image processing.

In step S1801, the image information acquisition unit 1612 acquires a movie or image from the image information management unit 376. In step S1802, the target information acquisition unit 1611 acquires the signage target information 500 from the signage target information management unit 375. In step S1803, the reversing unit 1613 performs a left-right inversion process on the movie or image acquired in step S1801. In step S1804, the decoding unit 1614 extracts a still image group by decoding the inverse movie or image. In step S1805, the first division unit 1615 substitutes 1 for the still image counter n.

In step S1806, the first division unit 1615 performs a first division process on the n-th still image. The details of the flowchart of the first division process will be described later. In step S1807, the first division unit 1615 determines whether or not the first division processing is performed for each the still images. If it is determined in step S1807 that there is a still image that is not subjected to the first division process (in the case of No in step S1807), the process proceeds to step S1808. In step S1808, the first division unit 1615 increments the still image counter n, and then returns to step S1806.

On the other hand, if it is determined in step S1807 that the first division process has been performed for each the still images, the process proceeds to step S1809.

In step S1809, the first division unit 1615, by dividing the plurality of division still images generated for each still image for each divided still image corresponding to the same window glass, generates a divided still image group for the number of window glasses and stores it in the image information management unit 376. In addition, the first division unit 1615 adds the divided still image group ID to each generated divided still image group, and stores it in the image information 600 in association with the window ID.

In step S1810, the correction unit 1616 substitutes 1 for the divided still image group counter m. In step S1811, the correction unit 1616 corrects the m-th divided still image group among the divided still image groups generated in step S1809 by using the corresponding correction parameter. In step S1812, the second division unit 1617 performs second division processing on the corrected m-th divided still image group. In step S1813, the second division unit 1617 determines whether correction processing and second division processing are performed on each the divided still image groups generated in step S1809.

If it is determined in step S1813 that there is a divided still image group not subjected to the correction process and the second division process (in the case of No in step S1813), the process proceeds to step S1814. In step S1814, the correction unit 1616 increments the divided still image group counter m, and the process returns to step S1811. On the other hand, if it is determined in step S1813 that the correction process and the second division process are performed for all the divided still image groups (in the case of Yes in step S1813), the process proceeds to step S1815. In step S1815, the encoding unit 1618 generates, by encoding the divided still image group subjected to the second division processing in units of the projector, a plurality of projection movie or images for the number of projectors. In addition, the encoding unit 1618 stores, in the image information 600, the generated date and time for the plurality of generated movie or images for projection. In step S1816, the transmission unit 1619 transmits the generated plurality of projection movie or images to the corresponding projectors.

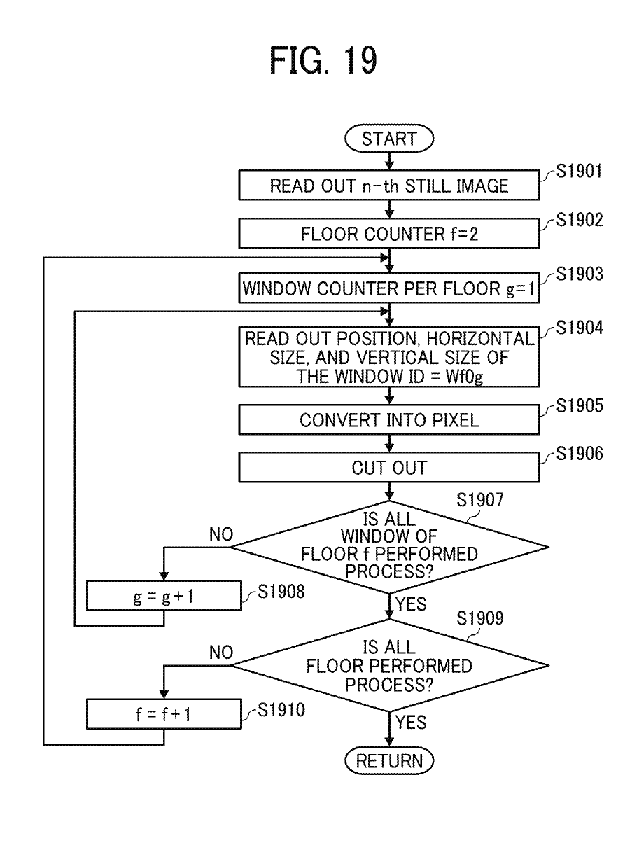

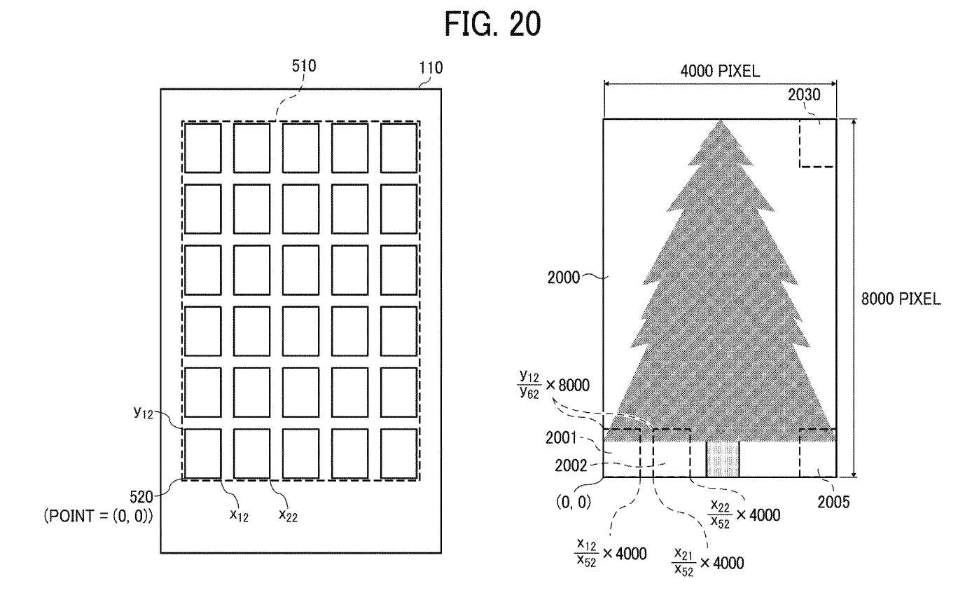

Next, the details of the first division processing (step S1806) will be described with reference to FIGS. 19 and 20. FIG. 19 is a flowchart showing the flow of the first division process. FIG. 20 is a diagram showing an example of the first division process.

In step S1901, the first division unit 1615 reads out the n-th still image. In FIG. 20, it is assumed that the still image 2000 is the n-th still image read by the first division unit 1615. In step S1902, the first division unit 1615 substitutes “2” into the floor counter f. In step S1903, the first division unit 1615 substitutes “1” in the window counter g for counting the number of window glasses per floor. In step S1904, the first division unit 1615 reads the “position”, the “horizontal size”, and the “vertical size” of the window ID=“Wf0 g” from the signage target information 500. Here, since “2” is assigned to f and “1” is assigned to g, the horizontal size (x 12, the vertical size (y 12), and the position ((0, 0)) correspond to the window ID=“W201” are read out.

In step S1905, the first division unit 1615 converts the position, the horizontal size, and the vertical size read in step S1904 into pixels on the still image 2000.

As shown in FIG. 20, in the present embodiment, it is assumed that the still image 2000 is configured to 4000 pixels in the horizontal direction and 8000 pixels in the vertical direction. In this case, the pixel on the still image 2000 corresponding to the position=“(0, 0)” is the pixel of position=“(0, 0)”.

Further, the pixels on the still image 2000 corresponding to the horizontal size (x 12) are pixels calculated by (x 12/x 52)×4000. Further, the pixels on the still image 2000 corresponding to the vertical size (y 12) are pixels calculated by (y 12/y 62)×8000.

In step S1906, the first division unit 1615 cuts out the rectangular area 2001 specified based on the pixel calculated in step S1905 from the still image 2000, and generates a divided still image. In step S1907, the first division unit 1615 determines whether or not the first division processing is performed for each the window glasses on the f floor. If it is determined in step S1907 that there is a windowpane that is not performing the first division process (in the case of No in step S1907), the process proceeds to step S1908. In step S1908, the first dividing unit 1615 increments the window counter g, and then returns to step S1904. As a result, “2” is assigned to g.

In step S1904, the first division unit 1615 reads the horizontal size (x 22−x 21), and the vertical size (y 12), and the position ((x 21, 0)) corresponding to the window ID=“W 202” from the signage target information 500. In step S1905, the first division unit 1615 converts the position, the horizontal size, and the vertical size read in step S1904 into pixels on the still image 2000 according to the comparison between the still image 2000 and the predetermined area 510.

As shown in FIG. 20, the pixel on the still image 2000 corresponding to the position ((x 21, 0)) is a pixel calculated by (x 21/x 52)×4000. Further, the pixels on the still image 2000 corresponding to the horizontal size (x 22−x 21) are pixels calculated by (x 22/x 52)×4000. Further, the pixels on the still image 2000 corresponding to the vertical size (y 12) are pixels calculated by (y12/y 62)×8000.

In step S1906, the first division unit 1615 cuts out the rectangular area 2002 specified based on the pixel calculated in step S1905 from the still image 2000, and generates a divided still image.

In step S1907, the first division unit 1615 determines whether or not the first division processing is performed for each the window glasses on the f floor. If it is determined in step S1907 that there is a windowpane that is not performing the first division process (in the case of No in step S1907), the process proceeds to step S1908. Thereafter, in step S1906, the processing of steps S1904 to S1906 is repeated until the rectangular region 2005 is cut out.

In step S1907, if it is determined that the first division processing is or has been performed for each the window glasses on the f floor (in the case of Yes in step S1907), the processing proceeds to step S1909.

In step S1909, the first division unit 1615 determines whether or not the first division processing is performed for each the floors. If it is determined in step S1909 that there is a floor not performing the first division process (in the case of No in step S1909), the process proceeds to step S1910.

In step S1910, the first dividing unit 1615 increments the floor counter f, and then returns to step S1903. Thereafter, in the floor counter f=7, the processing of steps S1904 to S1907 is repeated until the rectangular area 2030 is cut out.

If it is determined in step S1909 that the first division process is performed for each the floors (in the case of Yes in step S1909), the process returns to step S1807 in FIG. 18.

Next, the details of the signage control process (step S803) in the image projection system 300 will be described.

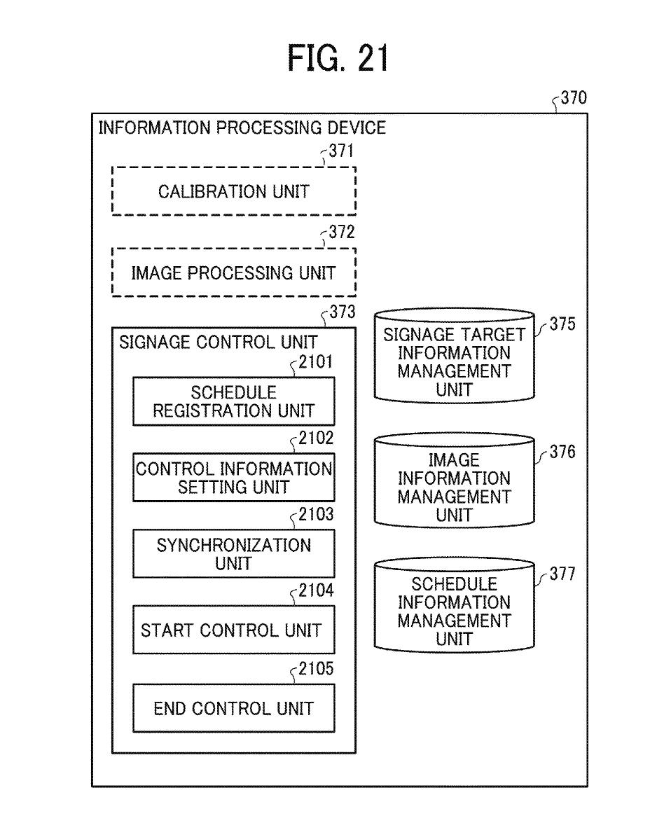

First, the functional configuration of the signage control unit 373 of the information processing device 370 that executes the signage control process will be described. FIG. 21 is a diagram showing a functional configuration of a signage control unit of the information processing apparatus.

As shown in FIG. 21, the signage control unit 373 includes a schedule registration unit 2101, a control information setting unit 2102, a synchronization unit 2103, a start control unit 2104, and an end control unit 2105.

The schedule registration unit 2101 functions as a first registration unit and a second registration unit, and executes a schedule registration process. Specifically, the schedule registration unit 2101 receives an input from the operator 1000 as to the digital signage schedule to be realized in the building 110. Further, the schedule registration unit 2101 generates schedule information (for example, schedule information 700) based on the input schedule, and stores it in the schedule information management unit 377.

The control information setting unit 2102 functions as a first designation unit and a second designation unit, and executes control information setting processing. Specifically, the control information setting unit 2102 receives from the operator 1000 the setting of the detailed operation of each signage device at the time of projection start and end. In addition, the control information setting unit 2102 generates start control information and end control information based on the setting of the accepted detailed operation, and stores it in the schedule information management unit 377 in association with the schedule information.

The synchronization unit 2103 outputs the time information. Further, the synchronization unit 2103 synchronizes the time between the projectors 310-1a to 310-30b and the information processing device 370. Specifically, the synchronization unit 2103 receives the time information from the time server 360, corrects the time information to be output, and transmits the corrected time information to the projectors 310-1a to 310-30b. The projectors 310-1a to 310-30b correct, by receiving the time information from the synchronization unit 2103, the time information managed internally. As a result, the synchronization unit 2103 synchronizes the time based on accurate time information between the projectors 310-1a to 310-30b and the information processing device 370.

The start control unit 2104 reads the schedule information stored in the schedule information management unit 377 and identifies the projection start time. The start control unit 2104 calculates instruction timing for the instruct of the operation of each signage device at the time of projection start based on the information on the time required for the operation of each signage device and the start control information associated with the schedule information. Further, the start control unit 2104 transmits an instruction on the operation at the time of projection start to each signage device at the calculated instruction timing. As the result, the signage control unit 373 performs to control each signage device in consideration of the time required for the operation of each signage device at the start of projection, and realize a digital signage with high visual effect at the start of projection.

The end control unit 2105 reads the schedule information stored in the schedule information management unit 377 and identifies the projection end time.

The end control unit 2105 calculates instruction timing for the instruct of the operation of each signage device at the time of projection end based on the information on the time required for the operation of each signage device and the end control information associated with the schedule information. Further, the end control unit 2105 transmits an instruction on the operation at the time of projection end to each signage device at the calculated instruction timing. As the result, the signage control unit 373 performs to control each signage device in consideration of the time required for the operation of each signage device at the end of projection, and realize a digital signage with high visual effect at the end of projection.

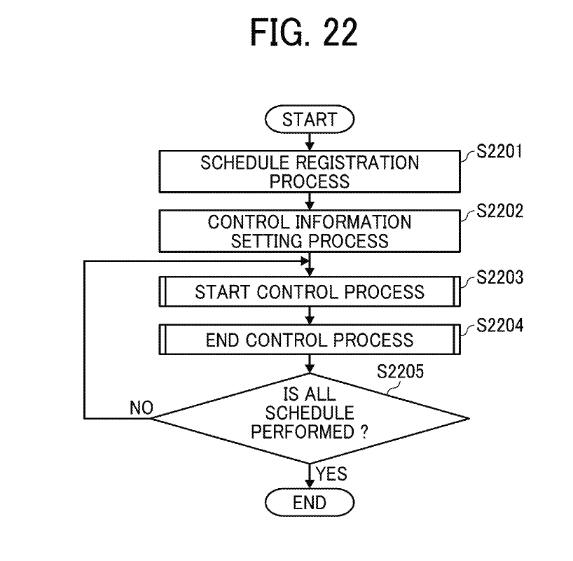

Next, the flow of the signage control process by the signage control unit 373 will be described. FIG. 22 is a flowchart showing the flow of signage control processing. After the image processing by the image processing unit 372, the signage control processing shown in FIG. 22 is executed.

In step S2201, the schedule registration unit 2101 generates schedule information by executing schedule registration processing, and stores the generated schedule information in the schedule information management unit 377. In step S2202, the control information setting unit 2102 generates the start control information and the end control information by executing the control information setting process, and stores, in the information management unit 377, the generated start control information and the end control information in association with the schedule information and schedules.

In step S2203, the synchronization unit 2103 and the start control unit 2104 execute a start control process and start projection with the projection movie or image. In step S2204, the end control unit 2105 executes the end control process and terminates the projection of the projection movie or image. In step S2205, the start control unit 2104 refers to the schedule information stored in the schedule information management unit 377 and determines whether or not each the schedules are executed. In step S2205, if it is determined that there is a schedule that is not being executed (in the case of No in step S2205), the process returns to step S2203. On the other hand, if it is determined in step S2205 that each the schedules are executed (in the case of Yes in step S2205), the signage control process is terminated.

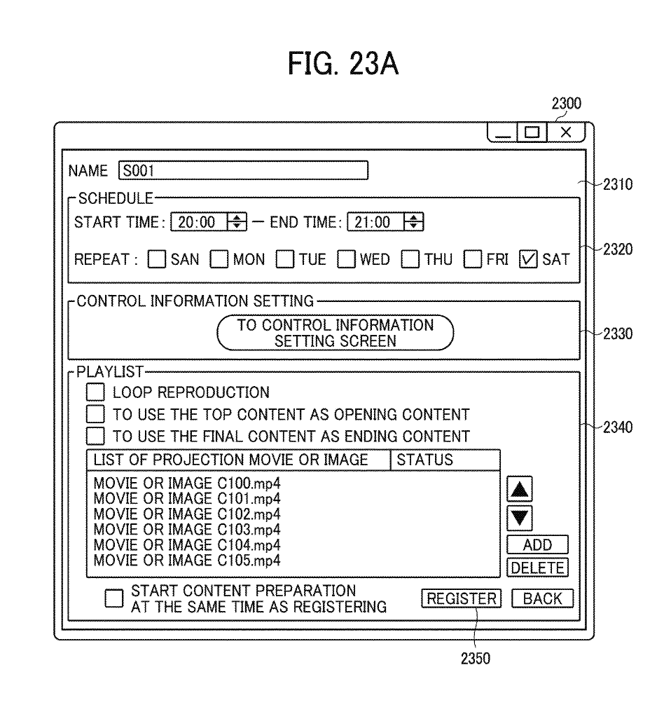

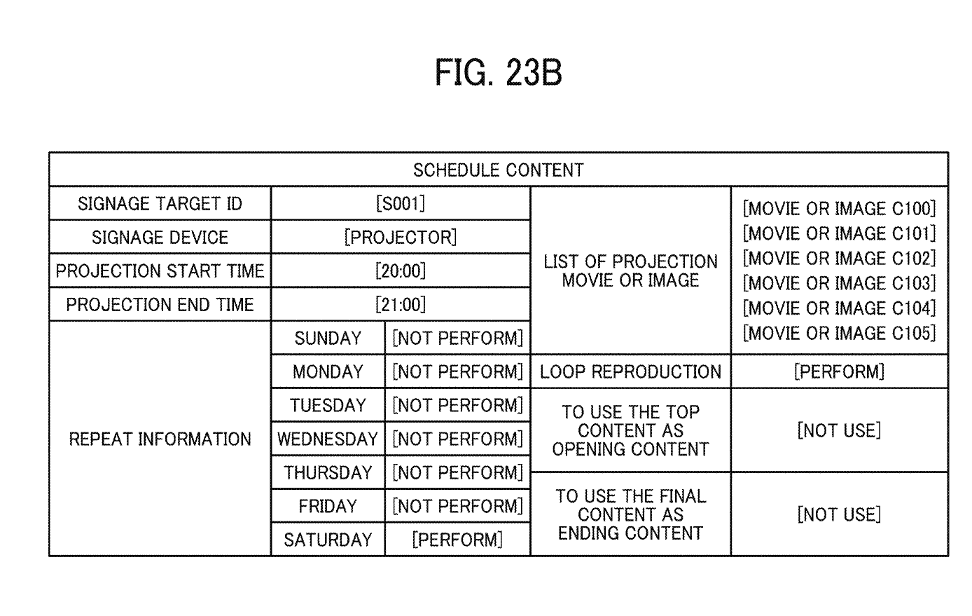

Next, the details of the schedule registration processing (step S2201) executed by the schedule registration unit 2101 will be described. FIGS. 23A and 23B illustrate a view of an example of a screen displayed on the information processing apparatus during a schedule registration process. When an instruction to activate the schedule registration unit 2101 is input by the operator 1000, a schedule registration screen 2300 is displayed on the display unit 405 of the information processing device 370.

As shown in FIG. 23A, the schedule registration screen 2300 includes a name input column 2310, a schedule input column 2320, a control information setting column 2330, and a play list column 2340.

In the name input field 2310, a signage target ID for identifying a signage target on which digital signage is realized is input. The example in FIG. 23A shows a case where the signage target ID=“S 001” indicating the building 110 is input.

The schedule input field 2320 includes a field for inputting projection start time and projection end time of the projection movie or image and a field for selecting the day of the week for projection of the projection movie or image. In the example of FIG. 23A, it indicates that settings for projecting a movie or image for projection is input from 20:00 to 21:00 every Saturday.

The control information setting field 2330 includes transition buttons for activating the control information setting unit 2102 and transitioning to a control information setting screen for generating start control information and end control information. The details of the control information setting screen will be described later.

In the play list column 2340, a projection movie or image to be used for projection is selected, and a projection method of the projection movie or image is input. The selected projection movie or image is displayed on the projection movie or image list.

In the play list column 2340, “loop reproduction” is an item for setting to repeatedly project the selected projection movie or image from the projection start time to the projection end time. When “loop reproduction” is turned on, the selected projection movie or image is repeatedly projected from the projection start time to the projection end time. On the other hand, when “loop reproduction” is turned off, the selected projection movie or image is projected once each time projection is started.

In the playlist column 2340, “to use the top content as the opening content” is an item that becomes selectable with “loop reproduction” turned ON, and for setting that the top projection movie or image is projected once time at the start of projection. By turning ON the item, the projection movie or image (in the example of FIG. 23, the movie or images C101.mp4 to C105.mp4) other than the top of the projection movie or image is repeatedly projected from the projection start time to the projection end time. On the other hand, the top of the projection movie or image (movie or image C 100.mp4 in the example of FIG. 23) is performed once at the start of projection.

In the playlist column 2340, “to use the final content as the ending content” is an item that becomes selectable with “loop reproduction” turned on, and for setting that the final movie or image for is projected once time at the end of projection. By turning ON this item, the projection movie or image (in the example of FIG. 23, the movie or images C100.mp4 to C105.mp4) other than the final projection movie or image is repeatedly projected from the projection start time to the projection end time. On the other hand, the final projection movie or image (movie or image C105.mp4 in the example of FIG. 23) is projected once at the end of projection.

The registration button 2350 is an instruction button for storing the schedule contents inputted on the schedule registration screen 2300 as the schedule information 700 in the schedule information management unit 377.

FIG. 23B shows an example of the schedule contents (text information) stored in the schedule information management unit 377 as the schedule information 700 when the registration button 2350 is pressed by the operator 1000.

Although the schedule registration screen for the projector in the signage device is shown in FIGS. 23A and 23B, the schedule information 700 is also registered for the electric screen and the illumination device on the similar schedule registration screen.

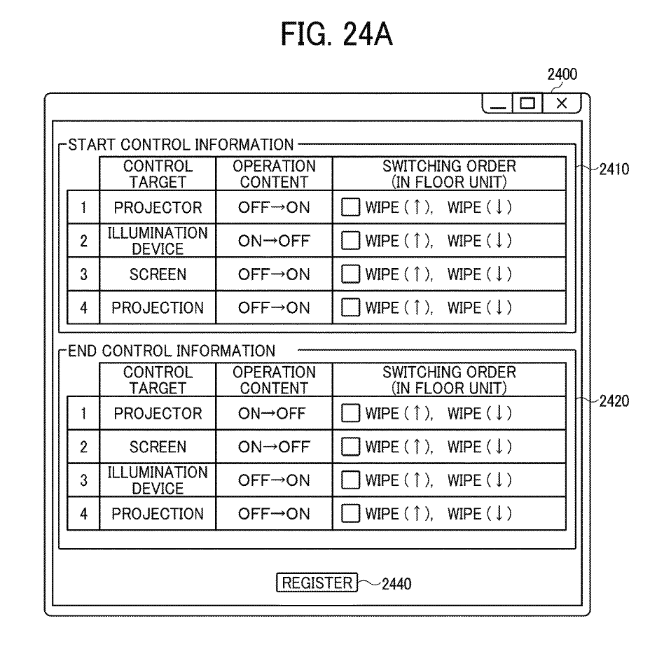

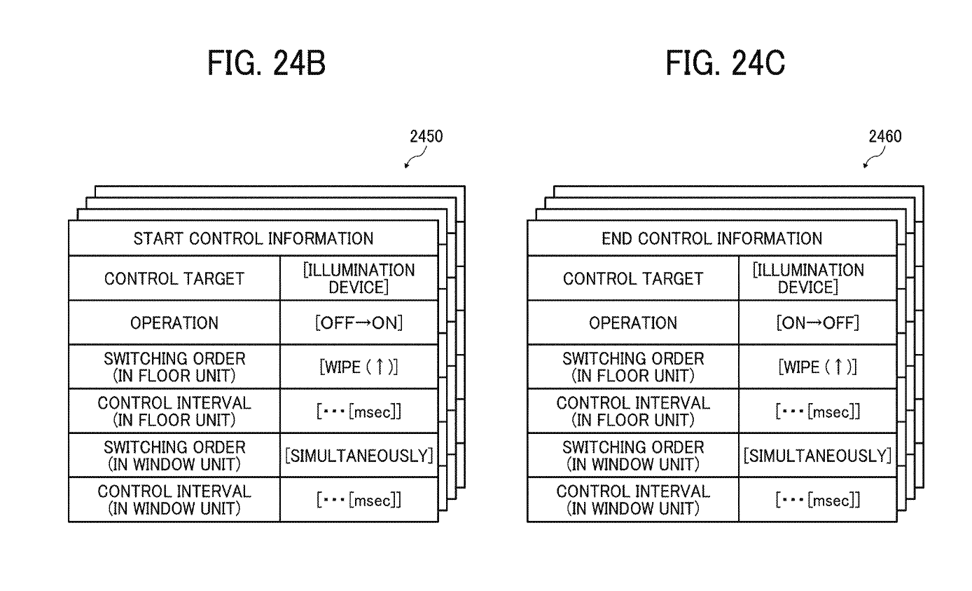

Next, the details of the control information setting process (step S2202) executed by the control information setting unit 2102 will be described. FIGS. 24A, 24B and 24C illustrate a view of an example of a screen displayed on the information processing apparatus during a control information setting process. In the control information setting field 2330 of the schedule registration screen 2300, when the operator presses the transition button, the control information setting unit 2102 is activated. As a result, on the display unit 405 of the information processing apparatus 370, a control information setting screen 2400 shown in FIG. 24A is displayed.

As shown in FIG. 24A, the control information setting screen 2400 includes a start control information input field 2410 and an end control information input field 2420.

In the start control information input field 2410, “control target”, “operation content”, “switching order (in floor unit)” are included as items of information. In the “control target”, a control target controlled at the start of projection is set. In the “control target” of FIG. 24A, the “projector” refers to the lamps of the projectors 310-1a to 310-30b. “Illumination” refers to illumination devices 140-1 to 140-6. “Screen” refers to the electric screens 330-1 to 330-30. Furthermore, “projection” refers to projection processing of the projection movie or image by the projectors 310-1a to 310-30b.

In the “operation content”, the operation content of the control target at the time of projection start is set. According to the example in FIG. 24A, the lamps of the projectors 310-1a to 310-30b operate from the OFF state to the ON state at the start of projection. In addition, the illumination devices 140-1 to 140-6 operate from the ON state to the OFF state at the start of projection. In addition, the electric screens 330-1 to 330-30 are operated from the OFF state to the ON state at the start of projection. Furthermore, at the start of projection, the projectors 310-1a to 310-30b perform projection processing on the projection movie or images included in the projection movie or image list.

In the “switching order”, the operation order of each control targets at the start of projection is set. In “switching order”, “wipe (↑)” indicates that the control targets sequentially perform the operation set to “operation content” from the lower floor to the upper floor at the start of projection. In addition, in the “switching order”, “wipe (↓)” indicates that the control targets sequentially perform the operation set to “operation content” from the upper floor to the lower floor at the start of projection.

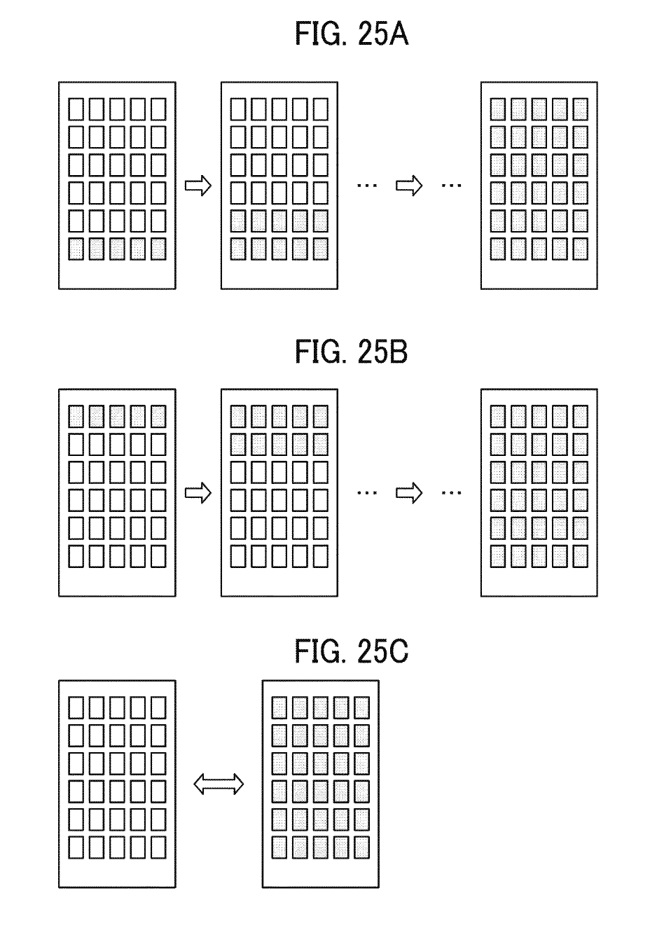

FIGS. 25A, 25B and 25C are illustrations for describing an example of operation of switching order. FIG. 25A shows the operation of“control target” when “wipe (↑)” is set in “switching order”. As shown in FIG. 25A, when “wipe (↑)” is set, first, the control target for the signage device arranged in 2F of the building 110 operates and next, the control target for the signage device arranged in 3F of the building 110 operates. Thereafter, the control targets for the signage devices arranged on the respective floors of the building 110 are sequentially operated.

FIG. 25B shows the operation of“control target” when “wipe (↓)” is set in “switching order”. As shown in FIG. 25B, when “wipe (↓)” is set, first, the control target for the signage device arranged in 7 F of the building 110 operates, and next, the control target for the signage device arranged in the 6 F of the building 110 operates. Thereafter, the control targets of the signage devices arranged on the respective floors of the building 110 are sequentially operated.

FIG. 25 (c) shows the operation of the control target when neither “wipe (↑)” nor “wipe (↓)” is set in “switching order”. As shown in FIG. 25 (c), when neither “wipe (↑)” nor “wipe (↓)” is set, the control target for the signage device arranged on each the floors of the building 110 are simultaneously operated.

Return to the explanation of FIGS. 24A, 24B and 24C. As shown in FIG. 24A, the end control information input field 2420 includes items of information similar to those of the start control information input field 2410, and similar contents are set.

The registration button 2440 is an instruction button for storing the start control information and the end control information set on the control information setting screen 2400 in association with the schedule information 700 in the schedule information management unit 377.

FIG. 24B shows an example of the start control information 2450 stored in the schedule information management unit 377 in association with the schedule information 700 as the registration button 2440 is pressed by the operator 1000. As shown in FIG. 24B, the start control information 2450 is stored for each control target.

In the control information setting screen 2400 of FIG. 24A, it is configured such that the operator 1000 set the “switching order” among the setting items of the start control information, and for the other setting items is set the default values. However, the other setting items also are configured to be set by the operator 1000.

For example, when “wipe (↑)” or “wipe (↓)” is set in “switching order”, the control interval is set. Further, in the description of the control information setting screen 2400, it is configured so that the switching on the floor basis is set by the operator 1000, but it is configured so that switching on a window glass basis is set. Further, in the case where the switching is made on the basis of the window glass, it is possible to further configure the control interval for each window glass.

FIG. 24C shows an example of the end control information 2460 stored in the schedule information management unit 377 in association with the schedule information 700 as the registration button 2440 is pressed by the operator 1000. As shown in FIG. 24C, the end control information 2460 is stored for each control target. Since the stored items are the same as the start control information 2450, the explanation is omitted here.

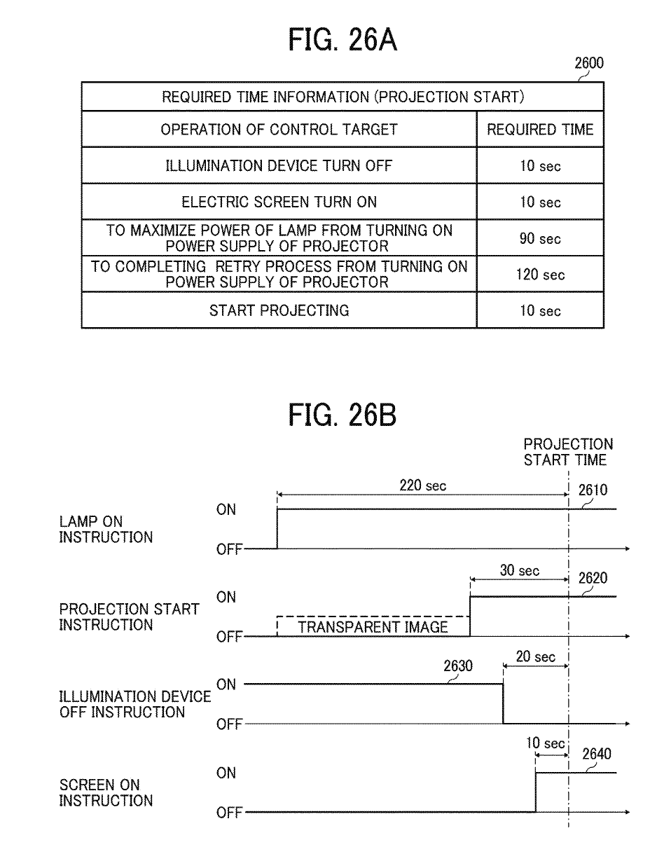

Next, the outline of the start control processing (step S2203) executed by the synchronization unit 2103 and the start control unit 2104 will be described with reference to FIGS. 26A and 26B. As described above, the start control unit 2104 calculates the instruction timing based on the information on the time required for the operation of each signage device and the start control information 2450 associated with the schedule information 700, and send an instruction of the operation to each of the signage devices.

FIGS. 26A and 26B are illustrations for describing an example of required time information and instruction timing for instructing operation of each signage device from starting the projection.

As shown in FIG. 26A, the required time information 2600 includes “operation of control target” and “required time” as items of information.

In the “operation of control target”, operation contents of each control target at the start of projection are stored. In the “required time”, the required time for the operation of each control target at the start of projection is stored.

According to the example of FIG. 26A, the time required for the illumination device 140-1 to 140-6 to actually turn off the illumination device 140-1 to 140-6 after receiving the illumination device OFF instruction is 10 seconds. Further, according to the example of FIG. 26A, the time required for the electric screens 330-1 to 330-30 to actually turn on the electric screens 330-1 to 330-30 after receiving the screen ON instruction is 10 seconds.

Further, according to the example of FIG. 26A, the time required for the projector 310-1a to 310-30b to maximize the power of the lamp after receiving the lamp ON instruction and turning on the power supply is 90 seconds. Further, according to the example of FIG. 26A, the time required for the projectors 310-1a to 310-30b to complete the retry process after receiving the lamp ON instruction is 120 seconds. Further, according to the example of FIG. 26A, the time required from the projectors 310-1a to 310-30b receive the projection start instruction until the projection movie or image is actually projected is 10 seconds.

Therefore, the start control unit 2104 transmits an operation instruction to each control target at the instruction timing shown in FIG. 26B at the time of projection start.

Specifically, as shown in a graph 2610, the start control unit 2104 transmits a lamp ON instruction to the projectors 310-1a to 310-30b before 220 seconds from the projection start time. In order to maximize the power of the lamps of all of the projectors 310-1a to 310-30b at the projection start time, the time as follow is required:

1. the projector 310-1a to 310-30b needs the time from receiving the lamp ON instruction until the lamp power to become maximum (90 seconds),

2. the projector 310-1a to 310-30b needs the time from receiving the lamp ON instruction until the retry processing is completed (120 seconds), and

3. the time required for sending the lamp ON instruction.

In the present embodiment, the time required for sending the lamp ON instruction is set to 10 seconds. Therefore, the start control unit 2104 sets the instruction timing to transmit the lamp ON instruction before 220 seconds (=90+120+10) of the projection start time.

Note that the projectors 310-1a to 310-30b project a transparent image on the corresponding window glass (electric screen) during from the lamp ON instruction is received until the projection start instruction is received. In general, the projector projects the standby image from the reception of the lamp ON instruction until the reception of the projection start instruction, but when the standby image is projected on each window glass of the building 110, the projection does not have good appearance, thus, in the present embodiment, a transparent image is projected.

Also, as shown in the graph 2620, the start control unit 2104 transmits a projection start instruction to the projectors 310-1a to 310-30b before 30 seconds from the projection start time. In the present embodiment, it is assumed that each projectors 310-1a to 310-30b are in a state capable of projecting the projection movie or image before 10 seconds from the projection start time. Although, the time as follow is required

1. the projectors 310-1a to 310-b needs the time from receiving the projection start instruction the projectors 310-1a to 310-b start the projection (10 seconds), and

2. the time required for sending the projection start instruction (10 seconds).

Also, as shown in a graph 2630, the start control unit 2104 transmits an illumination device OFF instruction to the illumination devices 140-1 to 140-6 before 20 seconds from the projection start time. In the start control unit 2104, the electric screens 330-1 to 330-30 are turned ON after each the illumination devices 140-1 to 140-6 are set in the OFF state.

Here, in order for each electric screens 330-1 to 330-30 to be in the ON state at the projection start time, it is necessary to consider the required time (10 seconds) required for the electric screen to be in the ON state.

Therefore, the start control unit 2104 transmits a screen ON instruction before 10 seconds from the projection start time (refer to the graph 2640). Then, in order to set each the illumination devices 140-1 to 140-6 to the OFF state before 10 seconds from the projection start time, it is necessary to consider the time (10 seconds) required for the illumination devices 140-1 to 140-6 to be in the OFF state.

Therefore, the start control unit 2104 transmits an illumination device OFF instruction to the illumination devices 140-1 to 140-6 before 20 seconds from the projection start time (refer to the graph 2630).

In FIG. 26B, for example, graphs 2630 and 2640 show instruction timings for one illumination device and one electric screen. When “simultaneous” is set as the “switching order” in the start control information 2450, the same timing as the graphs 2630 and 2640 for sending the instruction of operation is applied to other illumination devices and other electric screens.

On the other hand, when “wipe (↑)” is set as the “switching order” in the start control information 2450, the instruction of operation for another illumination devices is transmitted at the timing delayed a predetermined control interval from the timing indicated as graph 2630. When “wipe (↑)” is set as the “switching order” in the start control information 2450, the instruction of operation for another electric screens is transmitted at the timing delayed a predetermined control interval from the timing indicated as graph 2640.

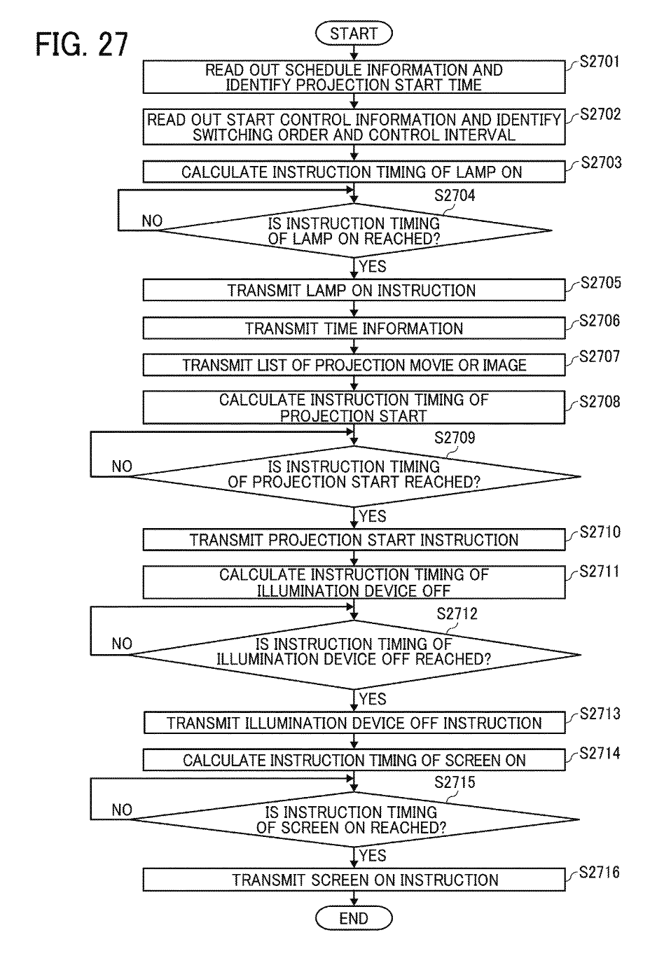

Next, the flow of the start control process (step S2202) by the synchronization unit 2103 and the start control unit 2104 will be described. FIG. 27 is a flowchart showing the flow of the start control process.

In step S2701, the start control unit 2104 reads the schedule information 700 stored in the schedule information management unit 377. In addition, the start control unit 2104 identifies the projection start time based on the read schedule information 700.

In step S2702, the start control unit 2104 reads the start control information 2450 associated with the schedule information 700. In addition, the start control unit 2104 identifies the switching order and the control interval of each control target based on the read start control information 2450.

In step S2703, the start control unit 2104 calculates the instruction timing of the lamp ON instruction for each of the projectors 310-1a to 310-30b, based on the projection start time, the switching order of the control target=“projector”, and the control interval. In calculating the instruction timing, the power of the lamps of the projectors 310-1a to 310-30b is maximized at the projection start time by considering the required time information 2600.

In step S2704, the start control unit 2104 determines whether or not the instruction timing of the lamp ON instruction for the projectors 310-1a to 310-30b is reached. If it is determined in step S2704 that the instruction timing of the lamp ON instruction is not reached (in the case of No in step S2704), it waits until it is determined that the instruction is reached.

On the other hand, if it is determined in step S2704 that the instruction timing of the lamp ON instruction is reached (in the case of Yes in step S2704), the process proceeds to step S2705. In step S2705, the start control unit 2104 transmits a lamp ON instruction to the projectors 310-1a to 310-30b. In step S2706, the synchronization unit 2103 receives the time information from the time server 360, corrects the time information managed inside the information processing apparatus 370, and transmits the corrected time information to the projectors 310-1a to 310-30b.

In step S2707, the start control unit 2104 transmits the projection movie or image list included in the schedule information 700 to the projectors 310-1a to 310-30b. In step S2708, the start control unit 2104 calculates the instruction timing of the projection start instruction for each of the projectors 310-1a to 310-30b, based on the projection start time, the switching order of the control target=“projection”, and the control interval. In calculating the instruction timing, the projector 310-1a to 310-30b are able to project the projection movie or image at the projection start time by considering the required time information 2600.

In step S2709, the start control unit 2104 determines whether or not the instruction timing of the projection start instruction for the projectors 310-1a to 310-30b is reached. If it is determined in step S2709 that the instruction timing of the projection start instruction is not reached (in the case of No in step S2709), it waits until it is determined that the instruction is reached.

On the other hand, if it is determined in step S2709 that the instruction timing of the projection start instruction is reached (in the case of Yes in step S2709), the process proceeds to step S2710. In step S2710, the start control unit 2104 transmits a projection start instruction to the projectors 310-1a to 310-30b. In step S2711, the start control unit 2104 calculates the instruction timing of the illumination device OFF instruction to each of the illumination devices 140-1 to 140-6 based on the projection start time, the switching order of the control target=“illumination device” and the control interval. When calculating the instruction timing, each the illumination devices 140-1 to 140-6 are set in the OFF state 10 seconds before the projection start time by considering the required time information 2600.

In step S2712, the start control unit 2104 determines whether or not the instruction timing of the illumination device OFF instruction to the illumination devices 140-1 to 140-6 is reached. If it is determined in step S2712 that the timing is not reached (in the case of No in step S2712), it is on standby until it is determined that it is reached. On the other hand, if it is determined in step S2712 that it is reached (in the case of Yes in step S2712), the process proceeds to step S2713. In step S2713, the start control unit 2104 transmits an illumination device OFF instruction to the illumination devices 140-1 to 140-6.

In step S2714, the start control unit 2104 calculates the instruction timing of the screen ON instruction for each of the electric screens 330-1 to 330-30 based on the projection start time, the switching order of the control target=“screen”, and the control interval. In calculating the instruction timing, each electric screens 330-1 to 330-30 are set in the ON state at the projection start time by considering the required time information 2600. In step S2715, the start control unit 2104 determines whether or not the instruction timing of the screen ON instruction for each of the electric screens 330-1 to 330-30 is reached. If it is determined in step S2715 that the instruction timing of the screen ON instruction is not reached (in the case of No in step S2715), it waits until it is determined that the instruction is reached.

On the other hand, if it is determined in step S2715 that it is reached (in the case of Yes in step S2715), the process proceeds to step S2716. In step S2716, the start control unit 2104 transmits a screen ON instruction to the electric screens 330-1 to 330-30. Thus, the start control processing by the start control unit 2104 is completed.

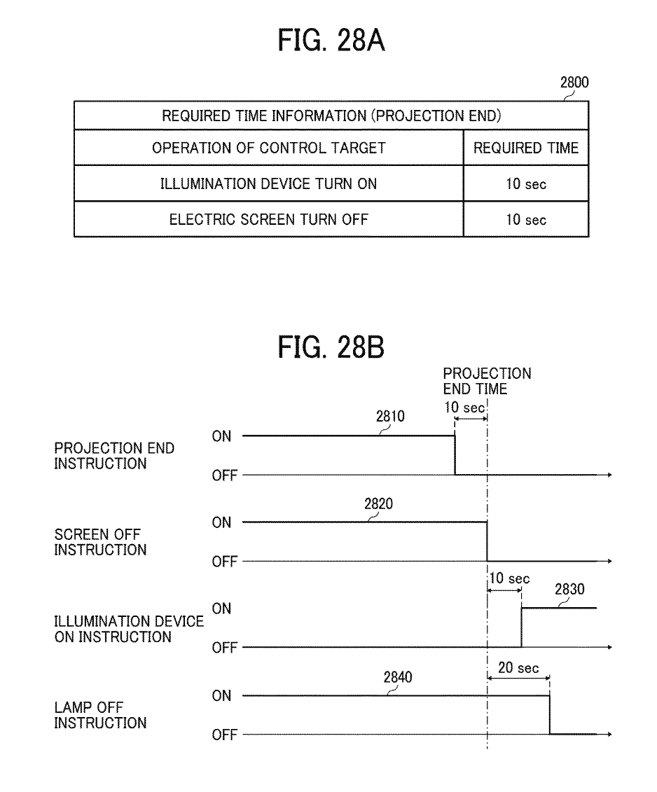

Next, the outline of the end control processing (step S2204) executed by the end control unit 2105 will be described with reference to FIGS. 28A and 28B. As described above, the end control unit 2105 transmits, at the instruction timing calculated on the basis of the information on the required time related to the operation of each signage device and the end control information 2460 associated with the schedule information 700, instruction of operation to each signage device. In the following description, it is assumed that the loop reproduction=“to” is selected as the schedule content and the projection of the projection movie or image is repeatedly performed until the projection end time is reached.

FIGS. 28A and 28B are illustrations for describing an example of required time information and instruction timing for instructing operation of each signage device from ending the projection.

As shown in FIG. 28A, the required time information 2800 includes “actions to be controlled” and “required time” as items of information.

In the “operation of control target”, operation contents of each control target at the end of projection are stored. In the “required time”, the time required for the operation of each control target at the end of projection is stored.

According to the example in FIG. 28A, the time required for the illumination devices 140-1 to 140-6 to actually turn on the illumination device 140-1 to 140-6 after receiving the illumination device ON instruction is 10 seconds.

Further, according to the example of FIG. 28A, the time required for the electric screens 330-1 to 330-30 to actually turn off the electric screens 330-1 to 330-30 after receiving the screen OFF instruction is 10 seconds.

Therefore, the end control unit 2105 transmits an operation instruction to each control target at the instruction timing shown in FIG. 28B at the end of the projection.

More specifically, as shown in the graph 2810, the end control unit 2105 transmits a projection end instruction to the projectors 310-1a to 310-30b before 10 seconds from the projection end time. In order that projection of the projection movie or image is completed at the projection end time, it is necessary to receive the projection end instruction at the projection end time. As described above, the time required to transmit the projection end instruction is 10 seconds.

Also, as shown in a graph 2820, the end control unit 2105 transmits a screen OFF instruction to the projection end time.

Further, as shown in a graph 2830, the end control unit 2105 transmits an illumination device ON instruction to the illumination devices 140-1 to 140-6 after 10 seconds from the projection end time. In order to turn on the illumination device 140-1 to 140-6 after the electric screens 330-1 to 330-30 are turned off, it is necessary to consider the time (10 seconds) required for the electric screens 330-1 to 330-30 to turn off.

Further, as shown in a graph 2840, the end control unit 2105 transmits a lamp OFF instruction to the projectors 310-1a to 310-30b 20 seconds after the projection end time. In order to turn OFF the lamps of the projectors 310-1a to 310-30b after the illumination devices 140-1 to 140-6 are in the ON state, it is necessary to consider the time (10 sec) required for the illumination devices 140-1 to 140-6 to be in the ON state.

In FIG. 28B, for example, graphs 2820 and 2830 indicate instruction timings for one electric screen and one illumination device. Therefore, when “simultaneous” is set as the “switching order” in the end control information 2460, the operation instruction is performed for the other electric screens and the other illumination devices at the same timing as the graphs 2820 and 2830.

On the other hand, when “wipe (↑)” is set as the “switching order” in the end control information 2460, the operation instruction is performed for another electric screen at the timing delayed by a predetermined control interval from the graph 2820. Further, the operation instruction is performed for another illumination devices at the timing delayed by a predetermined control interval from the graph 2830.

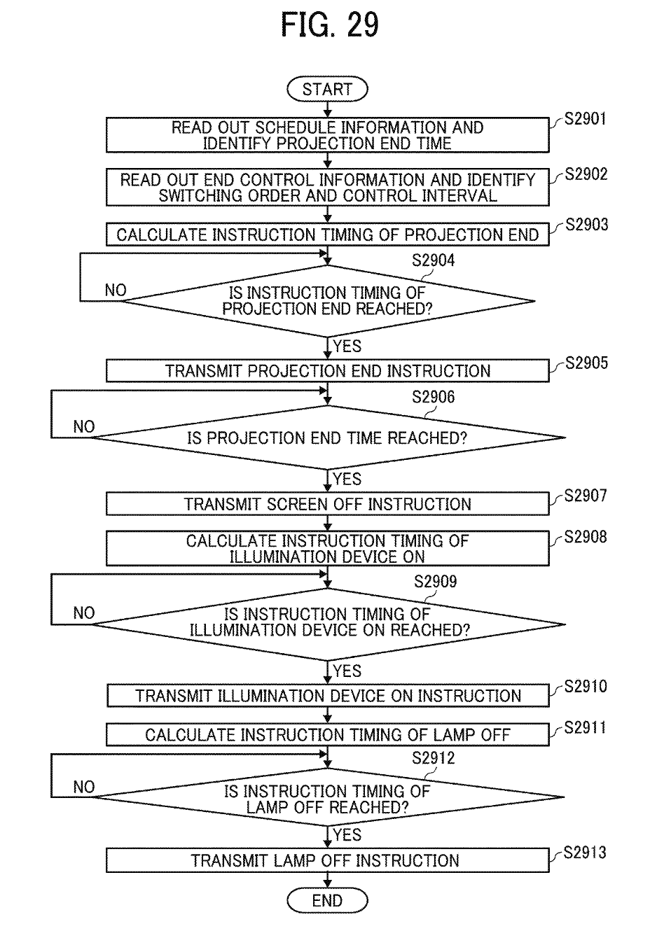

Next, the flow of the end control processing (step S2203) by the end control unit 2105 will be described. FIG. 29 illustrates a flowchart diagram including steps in an ending control process.

In step S2901, the end control unit 2105 reads out the schedule information 700 stored in the schedule information management unit 377. Further, the end control unit 2105 identifies the projection end time based on the read schedule information 700. In step S2902, the end control unit 2105 reads the end control information 2460 associated with the schedule information 700. Further, the end control unit 2105 identifies the control interval and the switching order of each control target based on the read end control information 2460. In step S2903, the end control unit 2105 calculates the instruction timing of the projection end instruction for each of the projectors 310-1a to 310-30b, based on the projection end time, the switching order of the control target=“projection”, and the control interval. The required time information 2600 is considered in calculating the instruction timing for the projection by the projectors 310-1a to 310-30b is completed at the projection end time.

In step S2904, the end control unit 2105 determines whether or not the instruction timing of the projection end instruction is reached. When it is determined in step S2904 that the instruction timing of the projection end instruction is not reached (in the case of No in step S2904), the process stands by until determining that the instruction timing of the projection end instruction is reached. On the other hand, when it is determined in step S2904 that the instruction timing of the projection end instruction is reached (in the case of Yes in step S2904), the process proceeds to step S2905.

In step S2905, the end control unit 2105 transmits a projection end instruction to the projectors 310-1a to 310-30b. In step S2906, the end control unit 2105 determines whether or not the projection end time is reached. When it is determined in step S2906 that the projection end time is not reached (in the case of No in step S2906), the process stand by until determining that the projection end time is reached. On the other hand, when it is determined in step S2906 that the projection end time is reached (in the case of Yes in step S2906), the process proceeds to step S2907. In step S2907, the end control unit 2105 transmits a screen OFF instruction to the electric screens 330-1 to 330-30.

In step S2908, the end control unit 2105 calculates the instruction timing of the illumination device ON instruction to each of the illumination devices 140-1 to 140-6 based on the projection start time, the switching order of the control target=“illumination device”, and the control interval. The required time information 2600 is considered in calculating the instruction timing for the illumination devices 140-1 to 140-6 are brought into the ON state after the electric screens 330-1 to 330-30 are all turned OFF.

In step S2909, the end control unit 2105 determines whether or not the instruction timing of the illumination device ON instruction to the illumination decorators 140-1 to 140-6 is reached. When it is determined in step S2909 that it is not reached (in the case of No in step S2909), the process stand by until determining that it is reached. On the other hand, when it is determined in step S2909 that it is reached (in the case of Yes in step S2909), the process proceeds to step S2910. In step S2910, the termination control unit 2105 transmits an illumination device ON instruction to the illumination devices 140-1 to 140-6.

In step S2911, the end control unit 2105 calculates the instruction timing of the lamp OFF instruction for each of the projectors 310-1a to 310-30b based on the projection start time, the switching order of the control target=“projector”, and the control interval. The required time information 2600 is considered in calculating the instruction timing for the lamps of the projectors 310-1a to 310-30b are turned OFF after all of the illumination device 140-1 to 140-6 are in the ON state.

In step S2912, the end control unit 2105 determines whether or not the instruction timing of the lamp OFF instruction for the projectors 310-1a to 310-30b is reached. When it is determined in step S2912 that the instruction timing of the lamp OFF instruction is not reached (in the case of No in step S2912), the process stand by until determining that the instruction is reached. On the other hand, when it is determined in step S2912 that the instruction timing of the lamp OFF instruction is reached (in the case of Yes in step S2912), the process proceeds to step S2913. In step S2913, the end control unit 2105 transmits a lamp OFF instruction to the projectors 310-1a to 310-30b. Thus, the termination control processing by the signage control unit 373 is completed.

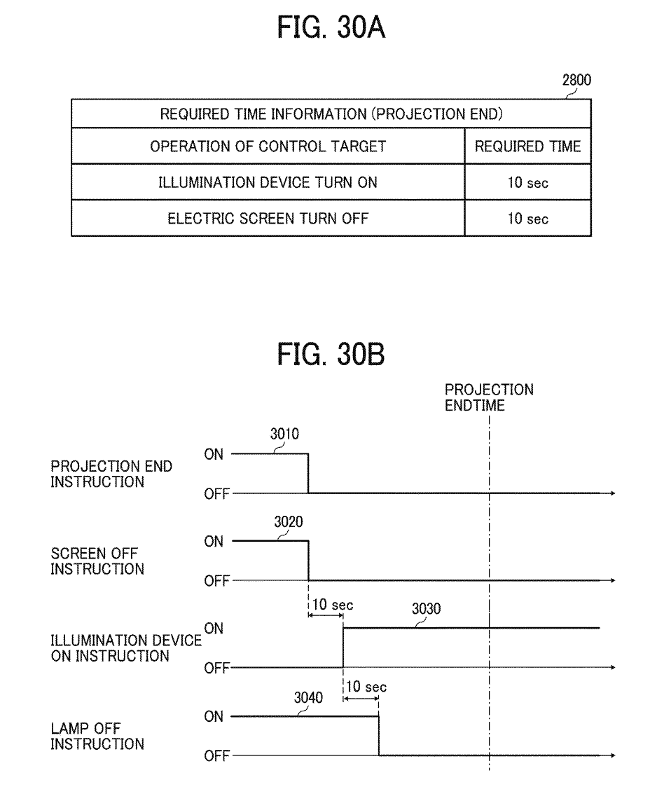

Next, the outline of another end control process (step S2204) executed by the end control unit 2105 will be described with reference to FIGS. 30A and 30B. Here, a description will be given of a case where loop reproduction=“not do” is selected as the schedule content and the projection of the projection movie or image is completed before reaching the projection end time.

FIGS. 30A and 30B are illustrations for describing another example of required time information and instruction timing for instructing operation of each signage device from ending the projection. Among them, FIG. 30A is the same as the required time information 2800 shown in FIG. 28A, so its explanation will be omitted here.

As shown in the graph 3010 in FIG. 30B, when once projection is performed for each projection movie or image included in the projection movie or image list of the schedule information 700, projection of the projection movie or image is end whether or not the projection end time is reached.

Upon completion of projection of the projection movie or image (see the graph 3010), the end control unit 2105 transmits a screen OFF instruction to the electric screens 330-1 to 330-30 (see the graph 3020). The time that is until the electric screens 330-1 to 330-30 to turn OFF after sending the screen OFF indication is 10 seconds. For this reason, the termination control unit 2105 transmits the illumination device ON instruction to the illumination devices 140-1 to 140-6 after 10 seconds have elapsed after sending the screen OFF instruction (see the graph 3030).

Also, the time that until the illumination device 140-1 to 140-6 to turn ON after transmitting the illumination device ON instruction is 10 seconds. For this reason, the termination control unit 2105 transmits a lamp OFF instruction to the projectors 310-1a to 310-30b after the lapse of 10 seconds (see the graph 3040) after transmitting the illumination device ON instruction.

As the above description, in the image projection system 300 according to the present embodiment, the inversion processing of the movie or image provided from the advertiser is performed. And, the still image of each frame extracted from the movie or image performed the inversion process is divided based on the position and the size of the plurality of window glasses included in the predetermined area on the outer surface of the building and a plurality of divided still image is generated from each still images. The divided still image group corresponding to the number of window glasses is generated by using divided still images of each frame corresponding to the same window glass and stored in the image information management section. Calibration processing is performed on projectors arranged at positions corresponding to a plurality of window glasses included in a predetermined area on the outer surface of the building, and the divided still image groups is corrected by using the correction parameters generated on the basis of the result of the calibration processing. The split still image group corrected is divided according to the number of projectors arranged at positions corresponding to one window glass and encoded, thereby generating a projection movie or image group for each projector. Projection movie or images of the generated projection movie or image group is projected on the electric screens corresponding to each of the plurality of window glasses via the corresponding projectors.

This makes it possible to realize a digital signage combining a plurality of light transmitting surfaces. Further, in the image projection system 300 according to the present embodiment, the operation of the electric screens and the illumination devices arranged at the position corresponding to each of the plurality of window glasses is controlled based on the projection start time. And the operation of the electric screens and the illumination devices arranged at the position corresponding to each of the plurality of window glasses is controlled based on the projection end time.

Thus, in the digital signage combining a plurality of light transmitting surfaces, the visual effect of the signage can be improved by interlocking the projecting device and other devices.

In the embodiment described above, at the start of projection, the operation instruction is transmitted to the control target in the order of the lamp ON instruction, the projection start instruction, the illumination device OFF instruction, and the screen ON instruction. However, on the other hand, the order of sending the operation instructions is not limited to this. The operation instructions may be transmitted in an order in order of higher visual effect at the start of projection.

Similarly, the operation instructions are transmitted to the control targets in the order of the projection end instruction, the screen OFF instruction, the illumination device ON instruction, and the lamp OFF instruction at the end of the projection. However, the order of sending operation instructions to the control targets are not limited to this. At the end of the projection, the operation instruction may be transmitted in an order in order of higher visual effect.

In the embodiment, an example of the timing of sending an operation instructions to the control targets is shown, however the timing which the start control unit 2104 or the end control unit 2105 transmits the operation instruction is not limited. It can be performed at another timing in order to higher visual effect.

Further, in the embodiment, as the switching order of the control targets, the vertical direction is set in the case of the floor unit, and the horizontal direction is set in the case of the window unit. However, the switching direction is not limited to this, and any direction can be set.

Further, in the embodiment, a case is described in which one pair of the projection start time and projection end time is registered in the schedule information 700, but a plurality of pairs of projection start time and projection end time can be registered. In this case, the start control process and the end control process described in the embodiment are executed at each projection start time and projection end time.

Further, in the embodiment, the information processing device 370 is described as having the calibration unit 371, the image processing unit 372, and the signage control unit 373, but some of these functions can be performed by another signage device.

Further, in the embodiment, the window glass attached to the predetermined area on the outer surface of the building 110 is described as the projection target, but the projection target is not limited to the window glass, can be other light transmitting surface. The light transmitting surface is not limited to the one attached to a predetermined area on the outer surface of the building 110. The light transmitting surface can be attached to a predetermined region inside the building 110, or attached other than the building 110.

It is to be noted that the present application is not limited to the configurations described in the above embodiments, such as combinations with other elements, and the like. With respect to these points, it is possible to change within a scope not deviating from the gist of the present invention, and it can be appropriately determined according to the application form.

What is claimed is:

1. The image projection apparatus, comprising:
processing circuitry configured to:
divide an image into a plurality of divided images in accordance with positions and sizes of a plurality of surfaces in a projection region;
control a plurality of projection devices to project the plurality of divided images onto the plurality of projection surfaces, each projection device of the plurality of projection devices corresponding to a different projection surface of the plurality of surfaces and projecting a divided image onto the corresponding different projection surface; and
control operation of another apparatus based on a timing so as to control an amount of light projected from a light source of a plurality of light sources, wherein
the plurality of light sources including the plurality of projection devices.

2. The image projection apparatus of claim 1, wherein
the another apparatus corresponds to a first projection surface of the plurality of projection surfaces, and
the another apparatus adjusts an amount of light, projected from a first projection device corresponding to the first projection surface, transmitted through the first projection surface.

3. The image projection apparatus of claim 2, wherein the another apparatus is between the first projection device and the first projection surface.

4. The image projection apparatus of claim 3, wherein the another apparatus blocks light projected from the first projection device.

5. The image projection apparatus of claim 1, wherein
the another apparatus is a device separate from the plurality of projection devices, and
the another apparatus emits light that is transmitted through a first projection surface.

6. The image projection apparatus of claim 5, wherein
the first projection surface is between the another apparatus and a first projection device corresponding to the first projection surface.

7. The image projection apparatus of claim 1, wherein
the plurality of projection surfaces are windows of a structure,
the plurality of projection devices are within the structure,
the light source is a first projection device of the plurality of projection devices,
the first projection device corresponds to a first projection surface of the plurality of projection surfaces, and
a first divided image is visible to a viewer outside of the structure when the processing circuitry controls operation of the another apparatus to control the amount of light, projected by the first projection device onto the first projection surface, to be a first amount.

8. The image projection apparatus of claim 1, wherein
the plurality of projection surfaces are windows of a structure,
the plurality of projection devices are within the structure,
the light source is separate from the plurality of projection devices, and
a first divided image is not visible to a viewer outside of the structure when the processing circuitry controls operation of the another apparatus to control the amount of light from the light source to be a first amount.

9. The image projection apparatus of claim 1, wherein the processing circuitry is further configured to transmit an operation instruction corresponding to a projection start time to the another apparatus based on the timing and in accordance with a required time to start the projection of the plurality of the divided images.

10. The image projection apparatus of claim 9, wherein the processing circuitry is further configured to
determine an order of the operation of the another apparatus and additional apparatus corresponding to the projection start time, the another and the additional apparatuses arranged at positions corresponding to each the plurality of the surface, and
transmit an operation instruction to each of the another apparatus and the additional apparatuses in the order.

11. The image projection apparatus of claim 1, wherein the processing circuitry is further configured to transmit an operation instruction corresponding to a projection end timing to the another apparatus based on a timing in accordance with a required time to end the projection of the plurality of the divided images.

12. The image projection apparatus of claim 11, wherein the processing circuitry is further configured to
determine an order of the operation of the another apparatus and additional apparatuses corresponding to the projection end time, the another apparatus and the additional apparatuses arranged at positions corresponding to each the plurality of the surface, and
transmit an operation instruction to each of the another apparatus and the additional apparatuses in the order.

13. An image projecting method, comprising: dividing, by processing circuitry, an image into a plurality of divided images in accordance with positions and sizes of a plurality of surfaces in a projection region; controlling, by the processing circuitry, a plurality of projection devices to project the plurality of divided images onto the plurality of projection surfaces, each projection device of the plurality of projection devices corresponding to a different projection surface of the plurality of surfaces and projecting a divided image onto the corresponding different projection surface; and controlling, by the processing circuitry, operation of another apparatus based on a timing so as to control an amount of light projected from a light source of a plurality of light sources, wherein
the plurality of light sources including the plurality of projection devices.

14. The image projecting method of claim 13, wherein
the another apparatus corresponds to a first projection surface of the plurality of projection surfaces, and
the another apparatus adjusts an amount of light, projected from a first projection device corresponding to the first projection surface, transmitted through the first projection surface.

15. The image projecting method of claim 14, wherein the another apparatus is between the first projection device and the first projection surface.

16. The image projecting method of claim 13, wherein
the another apparatus is a device separate from the plurality of projection devices, and
the another apparatus emits light that is transmitted through a first projection surface.

17. The image projecting method of claim 16, wherein
the first projection surface is between the another apparatus and a first projection device corresponding to the first projection surface.

18. The image projecting method of claim 13, wherein
the plurality of projection surfaces are windows of a structure,
the plurality of projection devices are within the structure,
the light source is a first projection device of the plurality of projection devices,
the first projection device corresponds to a first projection surface of the plurality of projection surfaces, and
a first divided image is visible to a viewer outside of the structure when the processing circuitry controls operation of the another apparatus to control the amount of light, projected by the first projection device onto the first projection surface, to be a first amount.

19. The image projecting method of claim 13, wherein
the plurality of projection surfaces are windows of a structure,
the plurality of projection devices are within the structure,
the light source is separate from the plurality of projection devices, and
a first divided image is not visible to a viewer outside of the structure when the processing circuitry controls operation of the another apparatus to control the amount of light from the light source to be a first amount.

20. A non-transitory computer readable medium storing computer executable instructions which, when executed by processing circuitry, causes the processing circuitry to:
divide an image into a plurality of divided images in accordance with positions and sizes of a plurality of surfaces in a projection region;
control a plurality of projection devices to project the plurality of divided images onto the plurality of projection surfaces, each projection device of the plurality of projection devices corresponding to a different projection surface of the plurality of surfaces and projecting a divided image onto the corresponding different projection surface; and
control operation of another apparatus based on a timing so as to control an amount of light projected from a light source of a plurality of light sources, wherein
the plurality of light sources including the plurality of projection devices.
